(19) United States
(12) Patent Application Publication
(10) Pub. No.: US 2012/0181770 A1
(43) Pub. Date: Jul. 19, 2012

(54) CYCLE HAVING AN ARM DRIVE AND A LEG DRIVE

(76) Inventor: Martin Kraiss, Ulm (DE)

(21) Appl. No.: 13/392,084

(22) PCT Filed: Aug. 26, 2010
(86) PCT No.: PCT/DE2010/000990

§ 371 Date: Feb. 23, 2012

(30) Foreign Application Priority Data
Aug. 26, 2009 (DE) 10 2009 038 606.8
Sep. 28, 2009 (DE) 10 2009 043 029.6
Oct. 15, 2009 (DE) 10 2009 049 647.5
Oct. 31, 2009 (DE) 10 2009 051 329.9
Nov. 26, 2009 (DE) 10 2009 055 723.3
Aug. 9, 2010 (DE) 10 2010 033 804.4

(51) Int. Cl. B62K 21/00; B62M 1/12

(52) U.S. Cl. 280/240

(57) ABSTRACT

The invention relates to a two-wheeled cycle having an arm crank drive and a leg crank drive. The cycle has steering by means of shaft legs, wherein the cycle is steered by tilting, and the cycle has at least one steering support element which dampens, limits, or fixes the steering motion or exerts a restoring force in the straight-ahead position of the steering wheel. In addition, the geometry of the steering axis and of the fork offset are optimized.

The invention relates to a two-wheeled cycle having an arm crank drive and a leg crank drive, in particular a steering front wheel.

A cycle is a vehicle that is driven by the cyclist by muscle power.

Known cycles with arm crank drive have a drive system that is mounted on the steering cycle fork, that is, the steering system. In the drive system, the driving forces lead to torque around the steering axis which are transferred to the steering. The steering system is thus adversely influenced by forces created when driving the cycle.

Known cycles with arm crank drive are also susceptible to external steering forces. Such external steering forces occur for example in the event of impacts (for example when driving through a pothole, or when the steering wheel suffers a severe impact) which act on the steering wheel.

In known cycles with arm and leg crank drive, steering by tilting and without a steering device, the steering wheel can tilt away laterally when the cycle is driven slowly or comes to a standstill. In known cycles with arm and leg crank drive, steering by tilting and without a steering device, the steering wheel can tilt away laterally when the steering wheel is lifted off the road surface. In such a situation the cycle is no longer directionally stable.

The task of the invention is that the cyclist should be able to transmit his driving force optimally to the cycle. The task of the invention is also to protect the steering of the cycle from the influence of driving forces and external forces acting on the steering wheel, to reduce their influence or to counter such forces. In addition, the steering wheel should maintain a stable course when it is lifted off the road surface and should not tilt away laterally when driving slowly and when coming to a standstill.

The cyclist should be able to drive the cycle with his entire force and still be able to steer the cycle safely and precisely.

The invention achieves the described task with a cycle in accordance with Claim 1 or through a method of driving this cycle in accordance with Claim 10.

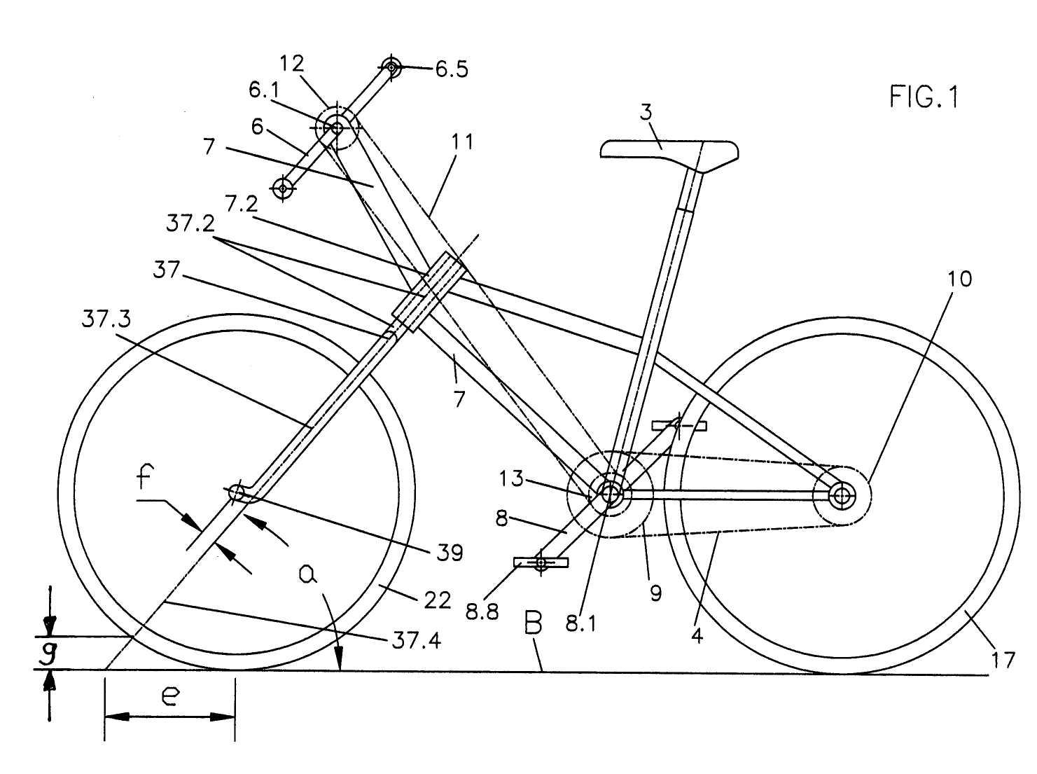

The invention achieves the described task by separating the drive movement from the steering movement in that it has steering by means of a stub axle. With this steering the cycle is steered by tilting, and this requires no additional steering actuation elements. In conventional two-wheeled cycles with exclusively leg drive, such an additional steering actuation element is a handlebar, for example. In known cycles with arm and leg crank drive, such an additional steering actuation element is for example a hand crank which is used for driving and for steering purposes. This known embodiment is described in the European patent application EP 06012476 in the embodiment as shown in FIG. 1.

The invention also achieves the described task in that it has at least one steering support element which dampens and/or limits and/or fixes the steering movement, and/or which exerts a reset force in the straight-ahead position of the steering wheel. In the invention, a steering support element is a steering damper, a steering angle limiter, a steering angle fixing device or a resetting element.

In some variants to which the invention relates, the steering is also made insensitive to external steering forces in that the angle of the steering axis is kept flat in relation to the contact surface of the cycle, the steering axis runs approximately through the axis of the front wheel or the steering axis runs in front of the axis of the front wheel.

The cycle to which the invention relates in its variant B1 to which the invention relates corresponds to variant A8 of European patent application EP 1 982 908 A1.

In the variant B1 to which the invention relates the cyclist drives the hand cranks 6 of the cycle with his arms as well as the leg cranks 8 of the cycle with his legs. The hand cranks 6 are rotatably mounted (FIG. 1) in the cycle frame 7 via the axle 6.1. Through the mounting of the hand cranks 6 in the cycle frame 7, the forces that act on the hand cranks 6 when driving the cycle are absorbed by the cycle frame 7 and are transmitted to the rear wheel via a synchronizing belt 11 and a drive chain 4. The advantage of this is that the steering is thus uncoupled from the drive and the driving forces are not transmitted to the steering. The driving force of the arms is simply transmitted via the synchronizing belt 11. This synchronizing belt 11 connects the hand cranks 6 via synchronizing pulleys 12,13 with the leg cranks 8 and runs parallel to the drive chain 4 of the rear wheel 17 (FIG. 1). Alternatively, the synchronizing belt 11 is a synchronizing chain 11 and the synchronizing pulleys 12, 13 are synchronizing chainwheels 12,13.

The hand crank handles 6.5 are rotatably mounted on the hand cranks 6. The leg cranks 8 are bolted to the axle 8.1. This axle 8.1 is rotatably mounted via the bottom bracket in the cycle frame 7.

To drive the cycle, the cyclist moves the hand cranks 6 with his hands and the leg cranks 8 with his feet. The pedals 8.8 are rotatably mounted on the leg cranks 8. Synchronizing pulleys 12, 13 are fixed on the cranks 6, 8. These are connected to each other via the synchronizing belt 11. This ensures that the cranks 6, 8 run synchronously. From the point of view of the rider, the synchronizing belt 11 runs to the right of the cycle frame 7. The drive chain 4 runs on the left-hand side of the cycle frame 7. This drives the rear wheel 17 via a drive chainwheel 9 which is securely connected to the leg crank 8 and via the drive cog 10. Alternatively, the drive chain 4, the drive chainwheel 9 and the drive cog 10 are located on the right-hand side and the synchronizing pulleys 12, 13 and the synchronizing belt 11 on the left-hand side.

For all variants to which the invention relates, the following applies: a stub axle is a movable arm on which a steering wheel is rotatably mounted. The specification of the sides “left” and “right”, in all of the variants described, means the sides from the point of view of the cyclist sitting on the cycle facing in the direction of travel.

As in the variant A8 of the European patent application EP 1 982 908 A1, the front wheel 22 steers in the variant B1 relating to the invention, and the steering of the cycle corresponds to the front wheel fork and the headset bearing of a conventional cycle. Here, the steering axis 37.4, seen in the direction of travel, is behind the axle 39 of the front wheel 22. However, the front wheel fork is not connected with a handlebar, as is usually the case with conventional cycles. Instead, the cyclist steers by tilting the cycle frame. The stub axle 37 has approximately the same shape as that of the cycle fork of a normal cycle. This means that the two stub axle tubes 37.3 hold the axle 39 of the front wheel 22 at their ends and run to the right and to the left of the front wheel 22 and then run together in the center axis of the cycle 7.3, where the two stub axle tubes 37.3 are firmly connected with the axle 37.2. In variant B1 the mounting of the stub axle 37 consists of the headset bearing tube 7.2, the headset bearing and the axle 37.2. The axle 37.2 is permanently connected to the two stub axle tubes 37.3 and thus with the stub axle 37 and is mounted via the headset bearing in the headset bearing tube 7.2, which is permanently connected to the cycle frame 7. The steering axis 37.4 is the common axis of the headset bearing, the headset bearing tube 7.2 and the axle 37.2.

The difference between the variant B1 to which the invention relates and the variant A8 of the European patent application EP 1 982 908 A1 is the angle of the steering axis (37.4) in relation to the contact surface B of the cycle. The steering axis (37.4) of variant B1 to which the invention relates is at a limited angle a of 30° to 65°, in particular of 35° to 60°, preferably of 40° to 55° in relation to the contact surface B of the cycle, proceeding from the contact surface B (FIG. 1). This is in contrast to variant A8 of the European patent application EP 1 982 908 A1. In this, the steering axis (37.4) is at a greater angle range of between 30° and 85° in relation to the contact surface B of the cycle, proceeding from the contact surface B. In variant A8 of the European patent application EP 1 982 908 A1 the angle range of 30° to 85° specified here corresponds to the angle range h of 95° to 150°, since there the angle is specified proceeding from the other side of the contact surface. In variant B1 to which the invention relates the angle a of 30° to 65°, in particular of 35° to 60°, preferably of 40° to 55° has the advantage that straight running is more stable and that the front wheel 22 is less susceptible to extreme lateral movements caused by external steering forces, e.g. caused by an impact against the front wheel 22.

The inclination a of the steering axis 37.4, in conjunction with the so-called rake f, causes the force of gravity of the cycle and of the cyclist, when the cycle is moving straight ahead, to keep the front wheel 22 in the straight-ahead position or at least, as of a certain steering angle, to lead to a reset force on the front wheel 22 back into the straight-ahead position and thus to make the cycle directionally stable. The rake f is also called fork bend. The rake f is the distance from the axle 39 of the front wheel 22 to the steering axis 37.4. Seen in the direction of travel, the fork bend, that is, the rake f, goes forwards. In the variant B1 to which the invention relates, the rake f is 0 mm to 400 mm, preferably 40 mm to 250 mm, in particular 70 mm to 150 mm. If the cyclist inclines the cycle frame 7 to the left approximately across the direction of travel, the stub axle 37, and thus the front wheel 22, then turns counterclockwise around the steering axis 37.4 and the cycle steers to the left.

If the cyclist inclines the cycle frame 7 to the right approximately across the direction of travel, the stub axle 37 and thus the front wheel 22, turns clockwise around the steering axis 37.4 and the cycle steers to the right.

Unlike variant A8 of the European patent application EP 1 982 908 A1, variant B1 to which the invention relates also has at least one steering support element (not illustrated) of the following variants to which the invention relates.

The variant B2 to which the invention relates corresponds to variant B1 to which the invention relates or one of the variants A4, A5, A6, A8 of the European patent application EP 1 982 908 A1. In variant B2 to which the invention relates the minimum of one steering support element is a steering damper. Optionally, variant B2 to which the invention relates also has at least one further steering support element of the other variants to which the invention relates.

The steering damper of variant B2 to which the invention relates is mounted between the stub axle 37 and the cycle frame 7. The steering damper damps the steering movement. Here the steering movement is the angle movement, that is, the rotating movement, of the stub axle 37 around the steering axis 37.4. Possible embodiments of the steering damper are such that are operated by means of a fluid or by means of a gas. Such dampers are already being used for damping the steering of motorcycles. These are dampers that work using the piston-cylinder principle or the wing principle. The damping is effected in that through the steering movement a compartment containing a fluid or a gas is made smaller. The fluid or gas can flow from the smaller compartment into another compartment in the steering damper and in this process must flow through several constrictions, also called nozzles. The passage through the constrictions leads to a pressure increase in the reduced volume in the compartment. This pressure increase creates a force against the steering movement and thus a damping of the steering movement.

In this process, the steering damping in variant B2 to which the invention relates increases proportionally, that is, in a linear manner, as the angular velocity increases. This means that at low angular velocities of the stub axle 37 the damping is lower that at high angular velocities of the stub axle 37. The angular velocity corresponds to the steering velocity of the stub axle.

Alternatively, in the steering damper to which the invention relates, the damping increases disproportionately, that is, progressively. This means that the increase in damping as the angular velocity of the stub axle 37 increases is not only proportional, that is, linear, but disproportional, that is, progressive. This corresponds to an above-average increase.

The progressiveness of the steering damper is achieved in that the above-mentioned constriction which the fluid or the gas of the damper has to flow through becomes narrower as the pressure difference between the two compartments of the damper increases—this means that the greater the pressure difference, the more the constriction closes. And since the pressure difference between the two compartments increases as the velocity of the damper piston increases, the constriction also closes increasingly and the damping force increases accordingly. Such progressively functioning steering dampers are available for motorcycles and these dampers are of the type RSC (Reactive Safety Control) by the company Hyperpro, or such dampers for motorcycles are described in the European patent application EP 1 477 397 A1. Unlike these known steering dampers for motorcycles, the damping characteristics of the steering dampers of the invention are designed specially for cycles, since with cycles the steering forces and steering velocities differ from those of motorcycles.

However, as for the above-mentioned steering dampers for motorcycles, it also applies for the steering damper of the invention that through the steering damper fast angular velocities of the stub axle are prevented and slow and medium angular velocities are permitted. Steering movements that are initiated by the cyclist are slow and medium steering velocities which accordingly are slightly damped by the steering damper or are virtually not damped at all. This means that the cyclist can steer the cycle without the steering movement being significantly damped by the steering damper. However, the steering damper damps strongly in the event of impacts (for example when driving through a pothole, or when a severe impact acts on the front wheel 22) acting on the steering wheel, in variant B1 to which the invention relates on the front wheel 22, for such impacts produce especially high angular velocities in the stub axle 37 around the steering axis 37.4, especially when they do not only act frontally on the steering front wheel 22, but also laterally. In such impacts, the steering damper thus prevents the stub axle 37 from making extreme lateral movements deviating from the steering direction. The steering damper also prevents an extreme lateral movement of the stub axle 37 in the event of such impacts.

By an extreme lateral movement of the steering wheel one understands a rotation of the steering wheel around the steering axis 37.4 of more than 90° from the straight-ahead position.

Steering dampers are of particular advantage for the variants to which the invention relates with a relatively small distance g. The distance g is the distance from the contact surface B to the intersection of the steering axis 37.4 with the external diameter of the front wheel.

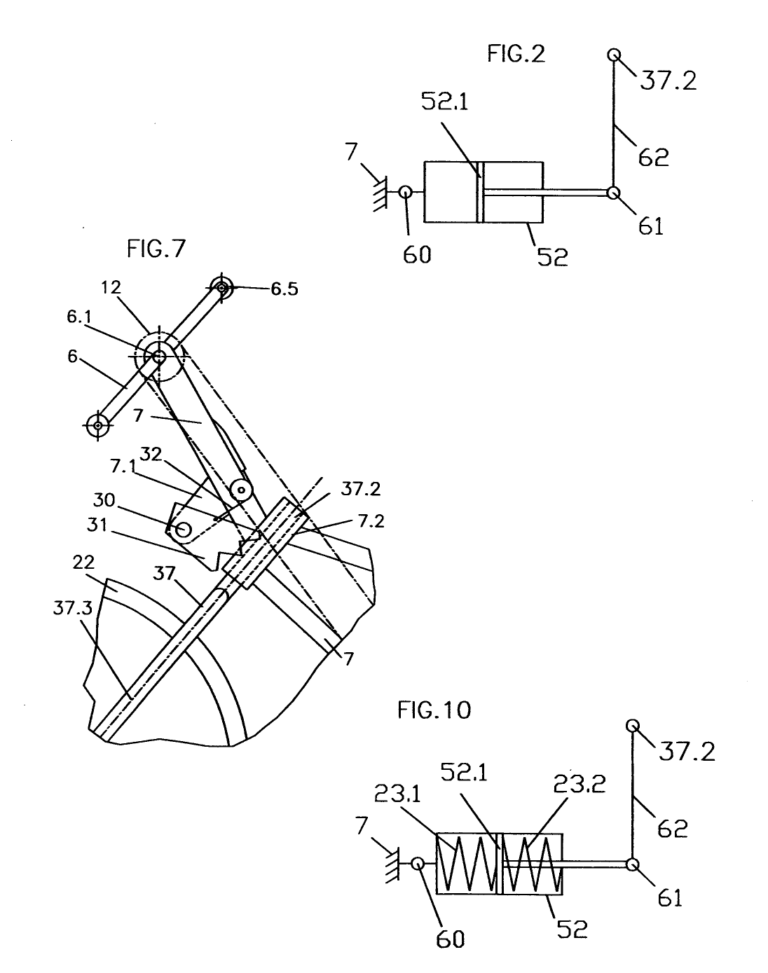

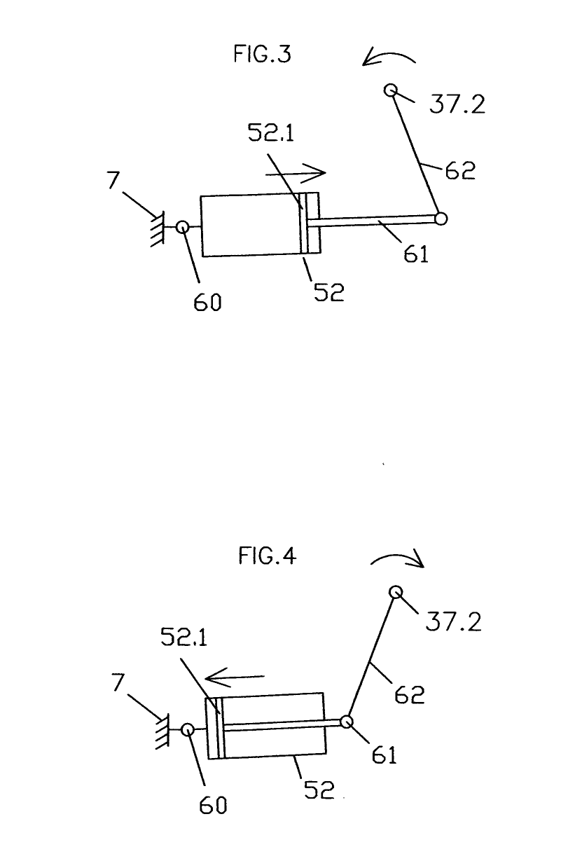

FIGS. 2, 3, 4 of variant B2 to which the invention relates show the diagrammatic view of a hydraulic steering damper 52 according to the piston-cylinder principle. FIGS. 2, 3, 4 show top views as seen along the steering axis 37.4. Details such as constrictions, among other things, are not shown. Here the piston 52.1 of the hydraulic steering damper 52 is connected to a rod 62 via a joint 61. The rod 62 is permanently connected to the axle 37.2 of the stub axle 37 of the cycle. The axle 37.2 and thus the stub axle 37 are rotatably mounted via the headset bearing in the cycle frame 7. The steering damper 52 is connected to the cycle frame 7 via a joint 60 on its cylinder base. If the axle 37.2 of the stub axle 37 rotates counterclockwise, the rod 62 rotates and the piston 52.1 is drawn out of the steering damper 52 (FIG. 3).

If the axle 37.2 of the stub axle 37 rotates clockwise, the rod 62 rotates and the piston 52.1 is pressed into the steering damper 52 (FIG. 4).

Alternatively the joint 61, instead of being connected to the rod 62, is connected directly to the stub axle 37. The joint 61 is connected to the stub axle 37 in a location which is not on the steering axis 37.4 (not illustrated). This allows the steering damper to effect torque around the steering axis 37.4.

Alternatively, instead of a damper according to the piston principle, the invention has a damper according to the wing principle. There are already steering dampers according to the wing principle for motorcycles of the type SD 415/425 by the company Öhlins.

Alternatively, in variant B2 to which the invention relates, the degree of the damping effect is not only dependent on the angular velocity of the stub axle but also on the angle position of the stub axle 37, that is, dependent on the steering movement angle.

This variable damping effect at different steering angles is achieved by enlarging or reducing the above-mentioned constriction which the fluid or the gas of the damper has to pass through as the piston position in the cylinder changes. Preferably the steering damping only becomes active as of a certain steering movement and becomes stronger as the steering angle increases. This damps the steering velocity of the stub axle at the end of the steering movement and prevents an overshooting of the stub axle towards the end of the steering knuckle movement. The end of the steering movement is the largest steering angle of a steering maneuver performed by the cyclist before he performs a steering maneuver in the other direction again. The reinforced damping at the end of the steering movement particularly prevents an overshooting of the stub axle at the reversal point at the end of the steering movement on account of the increasing reset force. This reset force can result from a cycle geometry in which the cycle gains potential energy in the event of a steering movement, or when the cycle also has a reset element of variant D to which the invention relates which exercises a reset force on the stub axle.

The variant B3 to which the invention relates corresponds to variant B1 to which the invention relates or one of the variants A4, A5, A6, A8 of the European patent application EP 1 982 908 A1. In variant B3 to which the invention relates the minimum of one steering support element is a steering angle limiter. Optionally, variant B3 to which the invention relates also has at least one further steering support element of the other variants to which the invention relates.

The mechanical steering angle limiter of the variant B3 to which the invention relates has two limit stops that are permanently attached to the cycle frame 7. The limit stops are parallel to each other and in the top view of the cycle are located one to the right and one to the left of the headset bearing tube 7.2.

The limit stops of the steering angle limiter limit the steering angle of the stub axle 37 and only permit a defined steering angle. When the defined steering angle has been reached, the limit stops strike the stub axle 37. This steering angle limiter prevents an extreme lateral movement of the stub axle in the event of impacts on the steering wheel, since the stub axle is prevented by the steering angle limiter from reaching large steering angles like those that occur when the steering wheel performs an extreme lateral movement. The steering angle limiter also prevents the steering wheel from tilting away laterally when the steering wheel is lifted off the road surface. Such a lift-off occurs when the cycle drives over a bump or jump at high speed and then the steering wheel lifts off the road surface for a short moment. Since the angle of the steering axle 37.4 is not perpendicular to the contact surface, the steering wheel tilts away laterally as soon as it is lifted off the contact surface.

Alternatively, the steering angle limiter can be adjusted step by step while driving.

The deactivation or the step-by-step adjustment of the steering angle limiter is effected by remote control. This remote control is a lever on the arm crank handle which actuates the steering angle limiter by means of a bowden cable 32 or a hydraulic line.

FIGS. 5, 6, 7 show such a steering angle limiter with step-by-step adjustment and remote control by means of a bowden cable. FIGS. 5, 6, 7 each show a part of the side view of a cycle to which the invention relates. The steering angle limiter consists of a shaft 30 and two limit stops 31 (FIG. 5). The limit stops 31 are permanently connected to each other via the shaft 30. The shaft 30 is rotatably mounted in a frame piece 7.1. The frame piece 7.1 is permanently connected to the cycle frame 7. The limit stops 31 are parallel to each other and in the top view of the cycle are located one to the right and one to the left of the headset bearing tube 7.2.

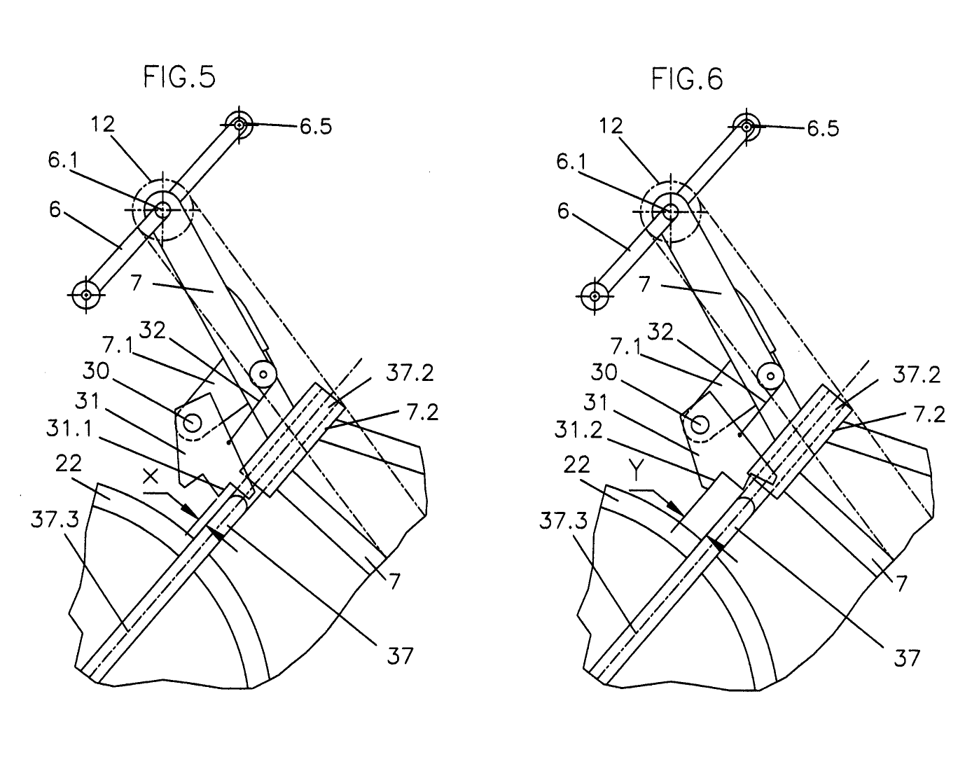

The steering angle limiter limits the steering angle of the stub axle 37 and only permits a defined steering angle. The mechanical limit stop 31 of the steering angle limiter has contact surfaces 31.1. In a straight-ahead position of the stub axle 37, these are at a distance x from the stub axle 37. During a steering movement of the stub axle, the distance x to one of the two limit stops 31 is reduced. The distance x to the other limit stop 31 increases. When the distance x is zero, the stub axle strikes a contact surface 31.1 and the steering movement is thus stopped. FIG. 6 shows the position of the steering angle limiter at which the contact surface 31.2 takes effect. During a steering movement of the stub axle the distance y is reduced. The distance y of the second stage of the steering angle limiter is larger than the distance x of the first stage of the steering angle limiter. When the distance y is zero, the stub axle strikes the contact surface 31.2 and the steering movement is thus stopped.

Alternatively, the steering angle limiter can be deactivated while driving. In the event of deactivation, the steering angle limiter is moved or swung away from the stub axle in such a way that it is no longer in the area of contact of the stub axle and thus no longer limits the steering angle. FIG. 7 shows the limit stop 31 in the deactivated position of the steering angle limiter. When the steering angle limiter is deactivated, the cyclist can drive a smaller turning circle.

Alternatively, this remote control is a switch on the arm crank handle which uses an electric circuit to switch an electric actuator on the steering angle limiter which actuates the steering angle limiter. Alternatively, the deactivation or the step-by-step adjustment of the steering angle limiter is effected directly in that the cyclist activates, deactivates or adjusts the latter step by step.

Alternatively, the steering angle limiter is a fluid or gas-driven steering damper as in the variant B2 to which the invention relates. If the damper in question is a damper according to the piston-cylinder principle, then the steering angle limit is reached when the piston 52.1 reaches one of its end positions in the cylinder 52, that is, when it is completely retracted or extended. If the damper in question is a damper according to the wing principle, then the steering angle limit is reached when the wing reaches one of its end positions in the wing housing, that is, when it is completely swiveled to the right or to the left.

The variant B4 to which the invention relates corresponds to the variant B3 to which the invention relates. Here, however, the stub axle is spring-mounted and controls the steering angle limiter. The spring-mounted stub axle is designed like a standard telescopic cycle fork which has two telescopic fork tubes, or the stub axle is designed like a spring-mounted rocker arm in which the stub axle is two-part and one part of the stub axle rocker is permanently connected to the axle 37.2 and on this the second part of the stub axle rocker in which the steering wheel is rotatably mounted is movably mounted.

Between the part of the stub axle connected to the axle 37.2 and the part of the stub axle movably mounted on said axle, a switching mechanism is mounted. When the spring-mounted stub axle is in extended position, the switching mechanism switches on the steering angle limiter, that is, it activates the steering angle limiter. If the steering wheel lifts off the road surface, the stub axle is extended and the steering angle limiter is activated. The steering wheel is thus prevented from tilting away laterally.

When contact is made with the road surface, the force of gravity of the cyclist and of the cycle acts on the stub axle, and this compresses and deactivates the steering angle limiter. This means that the cycle can be steered without steering angle limiter when it has road contact.

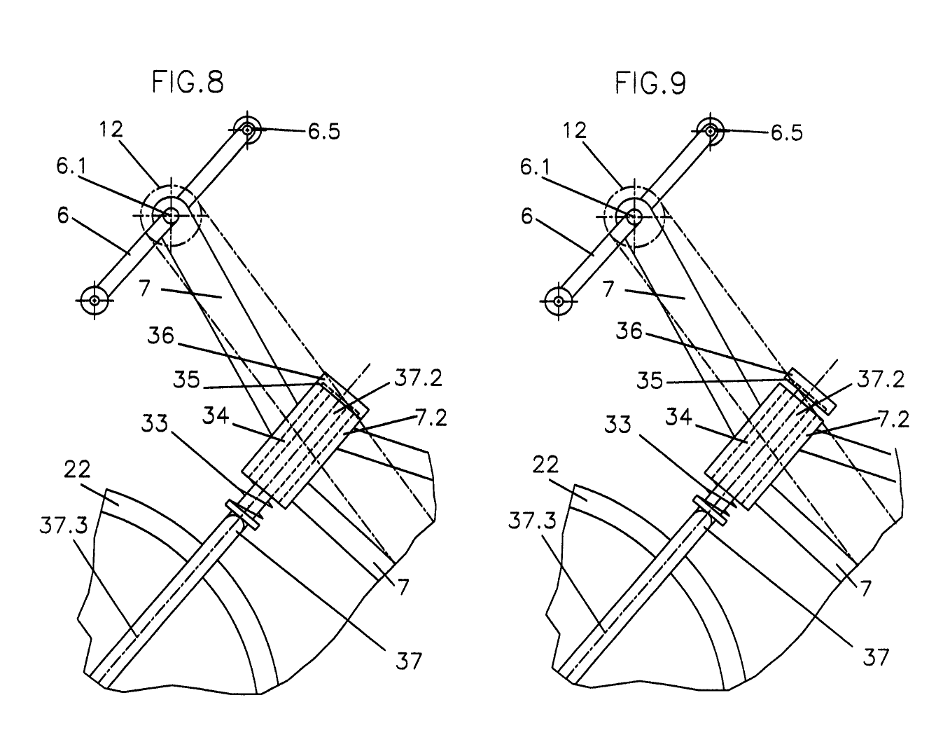

The variant B5 to which the invention relates corresponds to the variant B4 to which the invention relates. In variant B5 to which the invention relates the switching mechanism of the spring-loaded stub axle switches a steering fixing device on or off. When contact is made with the road surface, the force of gravity of the cyclist and of the cycle acts on the stub axle, and this compresses and deactivates the steering fixing device. This means that the cycle can be steered freely when it has road contact. If the steering wheel lifts off the road surface, the stub axle is extended and the steering fixing device is activated. This means that the steering is fixed in relation to the cycle frame, meaning blocked. The steering wheel is thus prevented from tilting away laterally. Such an embodiment of the switching mechanism is the spring-loaded stub axle 37 of its axle 37.2. The steering fixing device is a steering brake 36 (FIG. 8). FIGS. 8, 9 each show a part of the side view of the embodiment to which the invention relates. The stub axle 37 is movably mounted in a linear manner via the axle 37.2 in a linear bearing 34 and is spring-mounted via a spring 33 in relation to the linear bearing 34. This linear bearing 34 is rotatably mounted via the headset bearing in the headset bearing tube 7.2. At the upper end of the axle 37.2 a brake 36 is permanently mounted. When the stub axle 37 is extended, the friction surface 35 of the brake 36 comes into contact with the headset bearing tube 7.2 and thus creates a frictional connection between the stub axle 37 and the headset bearing tube 7.2 (FIG. 8). When the stub axle 37 is extended, the switching mechanism switches on the steering fixing device and the stub axle 37 is prevented by the brake 36 from turning in the headset bearing. When the stub axle retracts, the switching mechanism switches off the steering fixing device and the stub axle 37 can turn freely in the headset bearing (FIG. 9).

Alternatively, the steering fixing device is a locking device instead of a brake.

When this steering fixing device, that is, the locking device, is activated, a gearing system which is permanently connected to the stub axle 37 engages in a counter gearing system in the headset bearing tube 7.2 or in the cycle frame and thus the steering is fixed in relation to the cycle frame, meaning blocked. Alternatively, the steering fixing device is a blockable steering damper. Here, the steering damper is controlled. In this case, the switching mechanism switches the steering damper to block when the stub axle is extended. This means that the constriction or nozzle of the steering damper is closed completely by the switching mechanism and the fluid or gas flow between the compartments of the steering damper is prevented. When the axle retracts, the switching mechanism switches the constriction or nozzle to open and the fluid or gas flow can take place again between the compartments and the steering is thus free again. Alternatively, the switching mechanism switches the constriction in the steering damper to be continuously adjustable, that is, the damping increases as the retraction of the stub axle 37 increases. To achieve this, the cross-section of the constriction or nozzle of the steering damper is changed by means of the switching mechanism. The more the stub axle 37 retracts, the smaller the switching mechanism makes the cross-section of the constriction. For the damping of the steering, this means that the more the stub axle 37 retracts, the stronger is the damping of the steering damper. The advantage is that when driving through a pothole, the stub axle 37 retracts significantly, whereupon the switching mechanism increases the damping of the steering damper and the steering wheel thus remains directionally stable through the strong damping.

Alternatively, the switching mechanism has both functions, 1. blockable steering damping during extension and 2. continuously adjustable increase in damping when the stub axle 37 retracts.

As an alternative for all variants, the cycle also has an electric auxiliary motor. Such auxiliary motors are known. They are usually located in the drive hub of the rear wheel 17. Alternatively, the motor, including the relevant rechargeable battery, is located in the seat tube of the cycle. Gearwheels then connect the motor with the shaft of the leg cranks 8. The motor transmits its torque through these gearwheels to the leg cranks 8. The motor can be switched on by the cyclist parallel to the manual drive. With the help of the motor, the cyclist can still overcome steep climbs and accelerate even when he has already lost strength in his arms and legs after a long tour.

The variant D to which the invention relates corresponds to at least one of the other variants to which the invention relates or one of the variants A4, A5, A6, A8 of the European patent application EP 1 982 908 A1. In variant D to which the invention relates the minimum of one steering support element is a reset element which exerts a reset force on the stub axle 37 as soon as the latter is not in the straight-ahead position. Optionally, variant D to which the invention relates also has at least one further steering support element of the other variants to which the invention relates. The variant D to which the invention relates is of particular advantage when the steering of the cycle has a negative reset force. A negative reset force is a force opposed to the reset force. The negative reset force of the cycle steering occurs when the cycle, standing vertically on the contact surface, lowers itself in the event of a steering movement on account of the cycle geometry (trail, angle of the steering axis to the contact surface etc.), and thus loses potential energy.

Through the reset force of the reset element, the sum of the reset forces, that is, the sum of negative reset force in the cycle steering and reset force of the reset element, can become positive again. A reset force that is in sum positive contributes to directional stability and prevents the front wheel from tilting away laterally at low cycle speeds.

The FIGS. 10 to 18 and 36, 37, 38, 42, 45 show diagrammatic views of reset elements of cycles to which the invention relates. The FIGS. 10 to 18 and 36, 37, 38, 42, 45 show top views, seen along the steering axis 37.4.

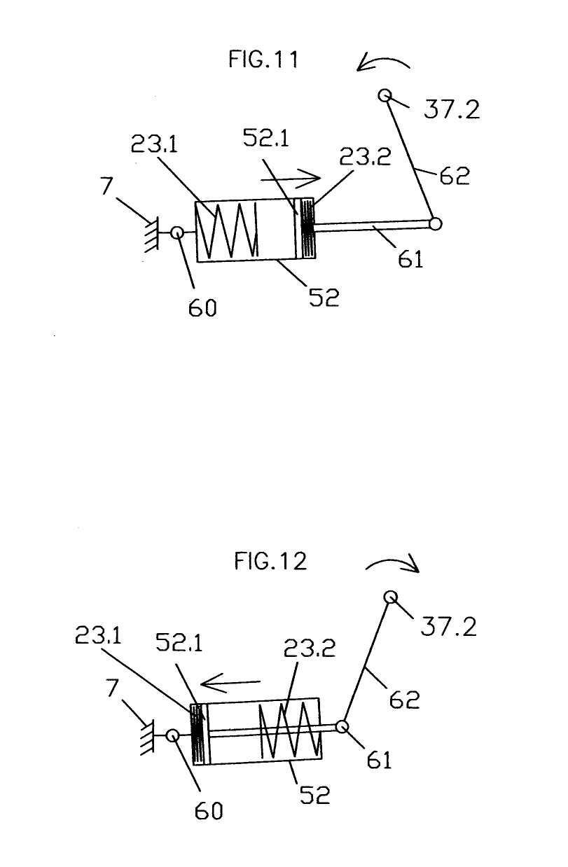

The variant D1 to which the invention relates corresponds to the variant D to which the invention relates. The variant D1 to which the invention relates is designed like the variant B2 to which the invention relates, but also has 2 reset elements in the form of coil springs 23.1, 23.2 (FIGS. 10, 11, 12). These are located one on either side of piston 52.1. Both springs 23.1, 23.2 have the same spring rate. In the straight-ahead position the springs are unloaded (FIG. 10), whereby the installation compartments for the springs 23 in the damper cylinder, along the longitudinal axis of the spring 52, are exactly as large as the springs 23 in relaxed state. In the event of a steering movement, one spring is tensioned and thus, through the spring force, exerts a reset force back to the straight-ahead position of the stub axle. If the cycle steers to the left, the axle 37.2 of the stub axle 37 including the rod 62 turns counterclockwise, and the piston 52.1 is drawn out of the steering damper 52 and the spring 23.2 is tensioned (FIG. 11).

If the cycle steers to the right, the axle 37.2 of the stub axle 37 including the rod 62 turns clockwise, and the piston 52.1 is pushed into the steering damper 52 and the spring 23.1 is tensioned (FIG. 12).

The advantage of this combination to which the invention relates is that the damper cylinder prevents an oscillation of the stub axle 37, in particular an overoscillation of the stub axle at the reversal point at the end of the steering movement on account of the increasing reset force of the reset element.

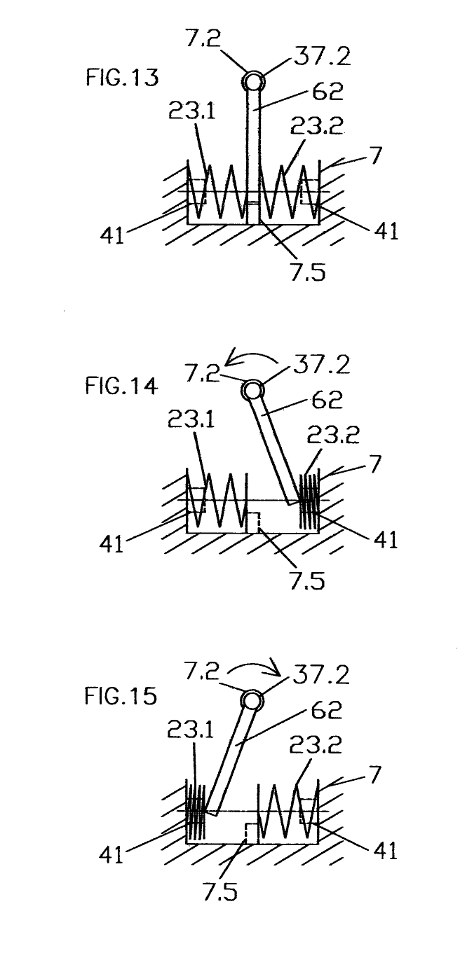

The variant D2 to which the invention relates corresponds to the variant D to which the invention relates. Unlike the variant D1 to which the invention relates, the two springs 23.1, 23.2 in the variant D2 to which the invention relates, instead of being in the damper cylinder 52, are installed between the cycle frame 7 and the stub axle 37, or the rod 62 (FIG. 13). In this case too, in the event of a steering movement, one installation compartment, along the longitudinal axis of the spring, becomes smaller for one spring.

If the cycle steers to the left, the axle 37.2 of the stub axle 37 including the rod 62 turns counterclockwise, and the spring 23.2 is tensioned (FIG. 14).

If the cycle steers to the right, the axle 37.2 of the stub axle 37 including the rod 62 turns clockwise, and the spring 23.1 is tensioned (FIG. 15).

Alternatively, in straight-ahead position, the springs 23.1, 23.2 are pretensioned instead of unloaded. In the straight-ahead position, the springs are tensioned against a limit stop 7.5 (displayed as a dotted line). The limit stop 7.5 is permanently connected to the cycle frame 7.

An alternative embodiment of the variant D2 to which the invention relates with an additional steering angle limiter of variant B3 to which the invention relates is shown as a dotted line in FIGS. 13, 14, 15. Two limit stops 41 (shown as dotted lines) for the rod 62 are permanently mounted within the springs 23.1, 23.2 on the cycle frame 7 and thus limit the steering angle and at the same time prevent the springs 23.1, 23.2 from bottoming. FIGS. 14, 15 show the rod 62 at the maximum possible steering angles, that is, when the rod 62 strikes each of the limit stops 41.

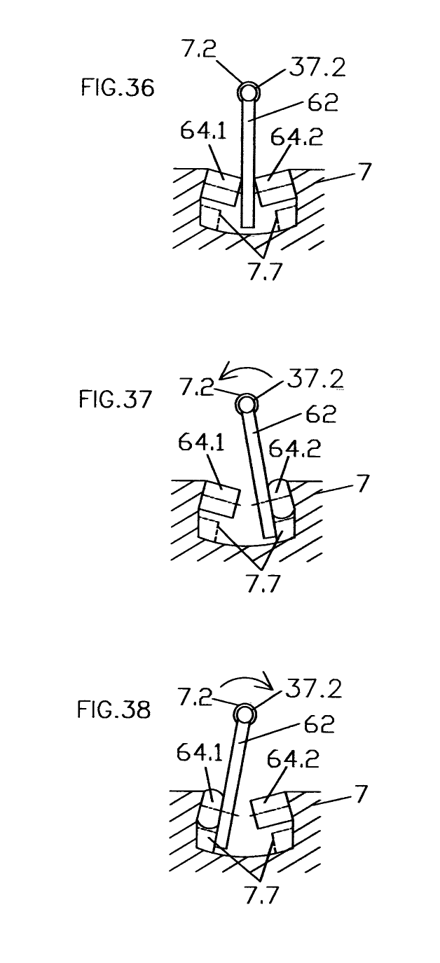

The variant D21 to which the invention relates corresponds to the variant D2 to which the invention relates. Unlike the variant D2 to which the invention relates, the variant D21 to which the invention relates has two rubber buffers 64.1, 64.2 installed (FIG. 36) instead of the two springs. FIGS. 36, 37, 38 show the variant D21 to which the invention relates in a top view as seen along the steering axis 37.4. In the event of a steering movement, one installation compartment for one rubber buffer becomes smaller, along the longitudinal axis of the rubber buffer.

If the cycle steers to the left, the axle 37.2 of the stub axle 37 including the rod 62 turns counterclockwise, and the rubber buffer 64.2 is tensioned (FIG. 37).

If the cycle steers to the right, the axle 37.2 of the stub axle 37 including the rod 62 turns clockwise, and the rubber buffer 64.1 is tensioned (FIG. 38).

Alternatively, in straight-ahead position, the rubber buffers 64.1, 64.2 are pretensioned instead of unloaded.

The advantage of rubber buffers compared with steel springs is that rubber buffers also have a damping effect on the steering movement.

An alternative embodiment of the variant D21 to which the invention relates with an additional steering angle limiter is shown as a dotted line in FIGS. 36, 37, 38. In this alternative embodiment, two limit stops 7.7 (shown as dotted lines) for the rod 62 are permanently mounted on the cycle frame 7 and thus limit the steering angle and at the same time prevent the rubber buffers 64.1, 64.2 from bottoming. FIGS. 37, 38 show the rod 62 at the steering angles at which the rod 62 strikes each of the limit stops 7.7. The limit stops are made of metal or preferably of a rubber or elastomer with greater hardness than the rubber buffers 64.1, 64.2.

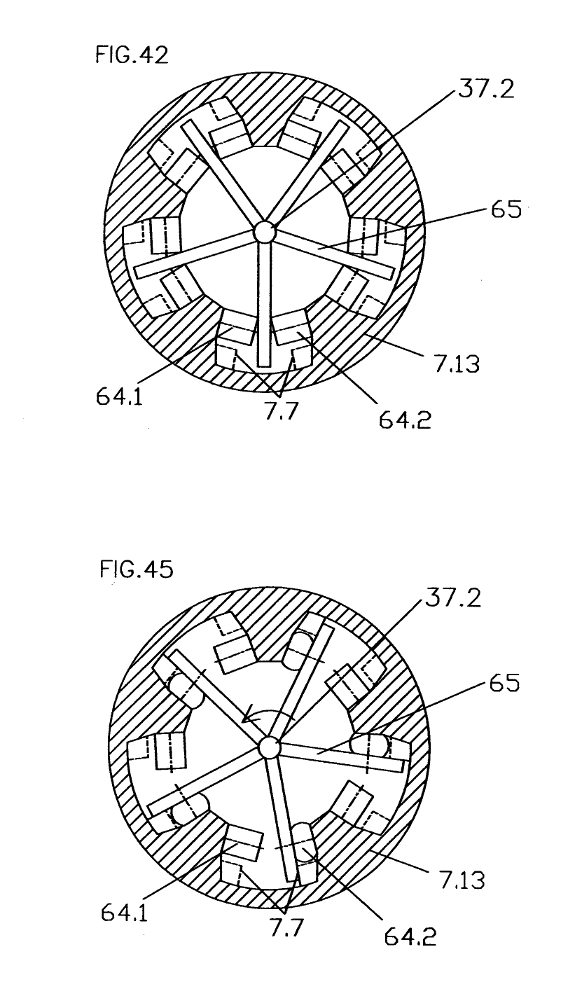

Alternatively, the variant D21 to which the invention relates has more than two rubber buffers. This means that the function of the reset element is still maintained to a limited extent in the event of the failure of a rubber buffer. FIGS. 42, 45 show this alternative embodiment in a top view as seen along the steering axis 37.4. In this alternative, a star gear 65 is permanently connected to the axle 37.2 of the stub axle 37. The center of the star gear 65 is located on the steering axis 37.4. The rubber buffers 64.1, 64.2 are located in a cage 7.13 which is permanently connected to the cycle frame. If the cycle steers to the left, for example, the axle 37.2 of the stub axle 37 including the star gear 65 turns counterclockwise, and the five rubber buffers 64.2 are tensioned (FIG. 45).

An alternative embodiment of the variant D21 to which the invention relates with a star gear 65 also has a steering angle limiter (FIGS. 42, 45). In this alternative embodiment, ten limit stops 7.7 (shown as dotted lines) for the star gear 65 are permanently mounted on the cage 7.13 and thus limit the steering angle and at the same time prevent the rubber buffers 64.1, 64.2 from bottoming. FIG. 45 shows the star gear 65 striking five of the limit stops 7.7 during a counterclockwise steering movement. The limit stops are made of metal or preferably of a rubber or elastomer with greater hardness than the rubber buffers 64.1, 64.2.

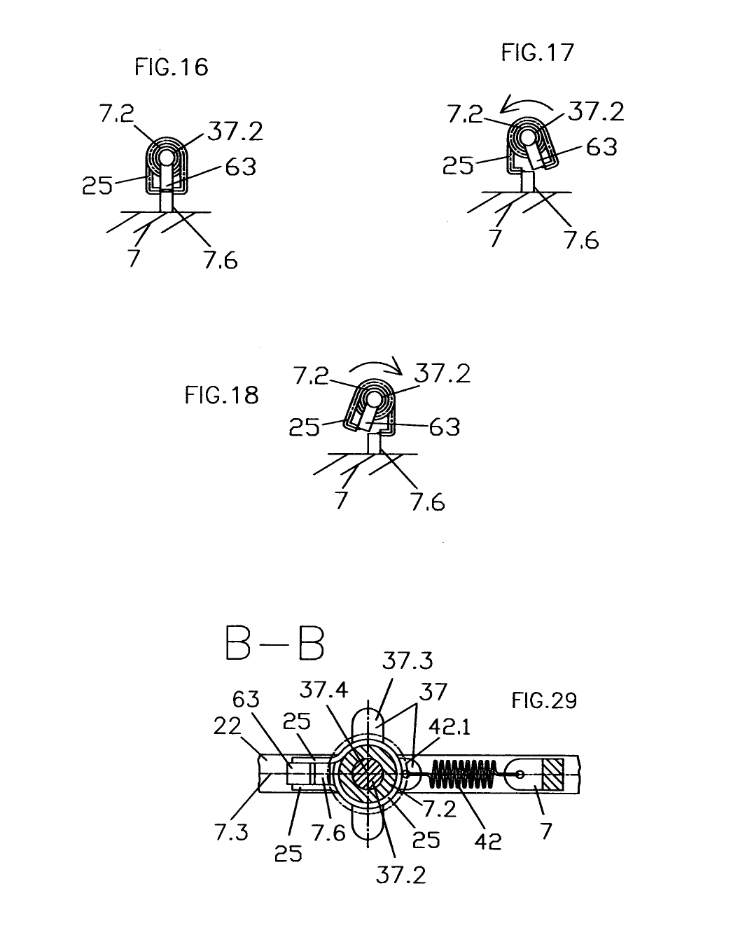

The variant D3 to which the invention relates corresponds to variant D to which the invention relates. Unlike the variants D1 and D2 to which the invention relates, the reset element in the variant D3 to which the invention relates, instead of being two coil springs, is a leg spring 25 (FIGS. 16, 20, 21).

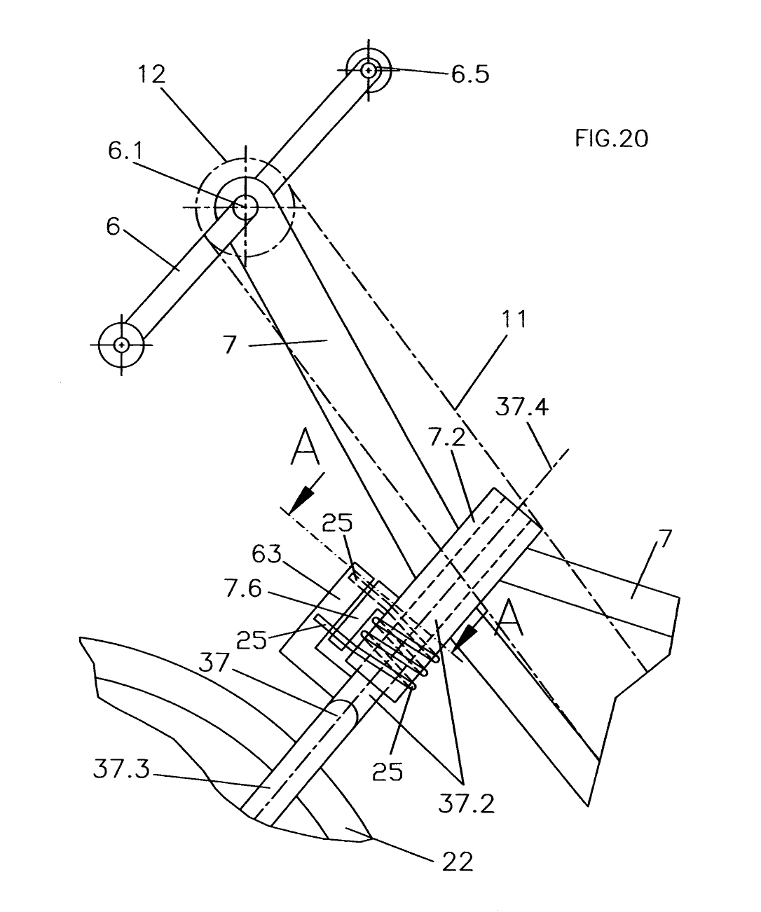

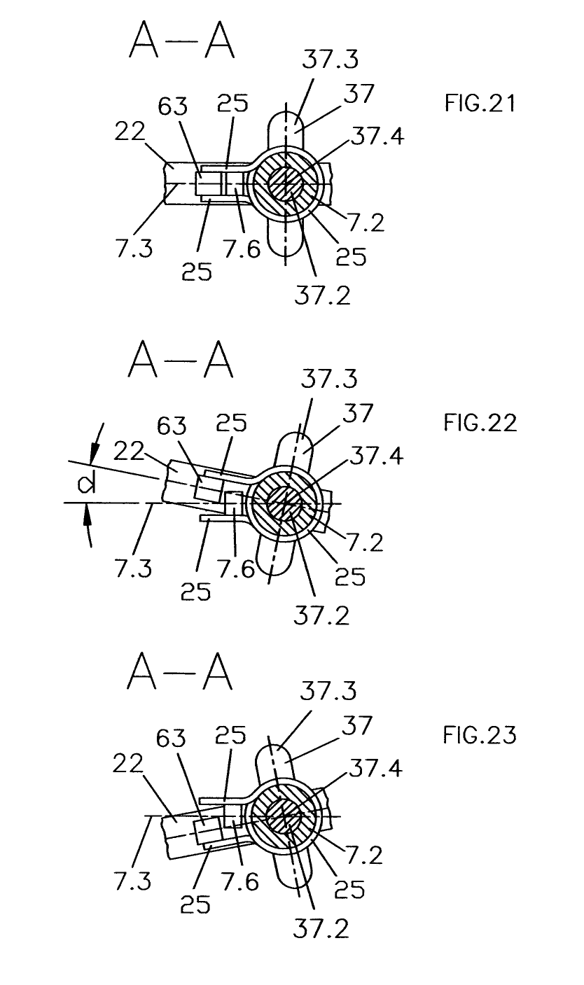

FIGS. 16, 17, 18 show a diagrammatic view and FIGS. 20, 21, 22, 23 show a less diagrammatic view of a cycle to which the invention relates. FIG. 20 shows a part of the side view of a cycle to which the invention relates. FIG. 21 shows section A-A of FIG. 20.

FIGS. 16, 21 show the stub axle 37 in straight-ahead position. FIGS. 22, 23 show the same section A-A as FIG. 21, but a different steering angle of the stub axle 37 and thus of the front wheel 22.

In the straight-ahead position, the leg spring 25 is unloaded and when the steering moves to the right or left it is tensioned. Both ends of the leg spring 25 are held by a limit stop 7.6 permanently connected to the cycle frame 7. The leg spring 25 is tensioned by a carrier 63 permanently connected to the stub axle 37, or its axle 37.2. In the event of a steering movement, this carrier 63 takes one end of the leg spring 25. At the same time the other end of the leg spring 25 is held by the limit stop 7.6. The coil spring 25 is thus tensioned by the two ends of the leg spring 25 being pushed apart. Through the tension of the coil spring 25, this exerts a reset force on the stub axle 37.

If the cycle steers to the left, the axle 37.2 of the stub axle 37 including the carrier 63 turns counterclockwise. The carrier 63 takes one end of the coil spring 25 and the leg spring 25 is tensioned (FIGS. 17, 23).

If the cycle steers to the right, the axle 37.2 of the stub axle 37 including the carrier 63 turns clockwise. In this case, the front wheel swings in relation to the center axis of the cycle 7.3 by the angle d. The carrier takes the other end of the coil spring and the leg spring 25 is tensioned (FIGS. 18, 22).

Alternatively, in straight-ahead position, the leg spring 25 is pretensioned instead of unloaded. Here, the leg spring 25 is pretensioned against the limit stop 7.6.

Alternatively the leg spring 25, the limit stop 7.6 and the carrier 63, protected against dirt, are located between axle 37.2 and the headset bearing tube 7.2 (not illustrated).

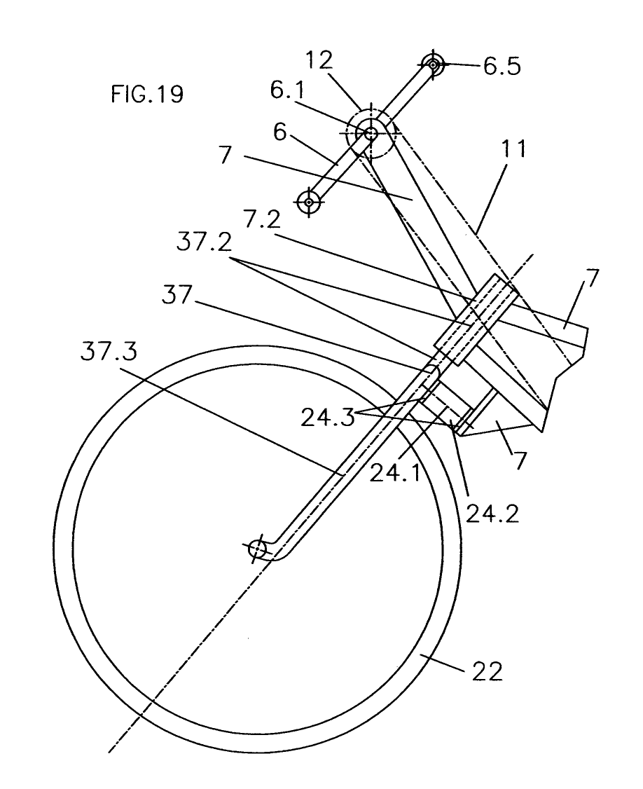

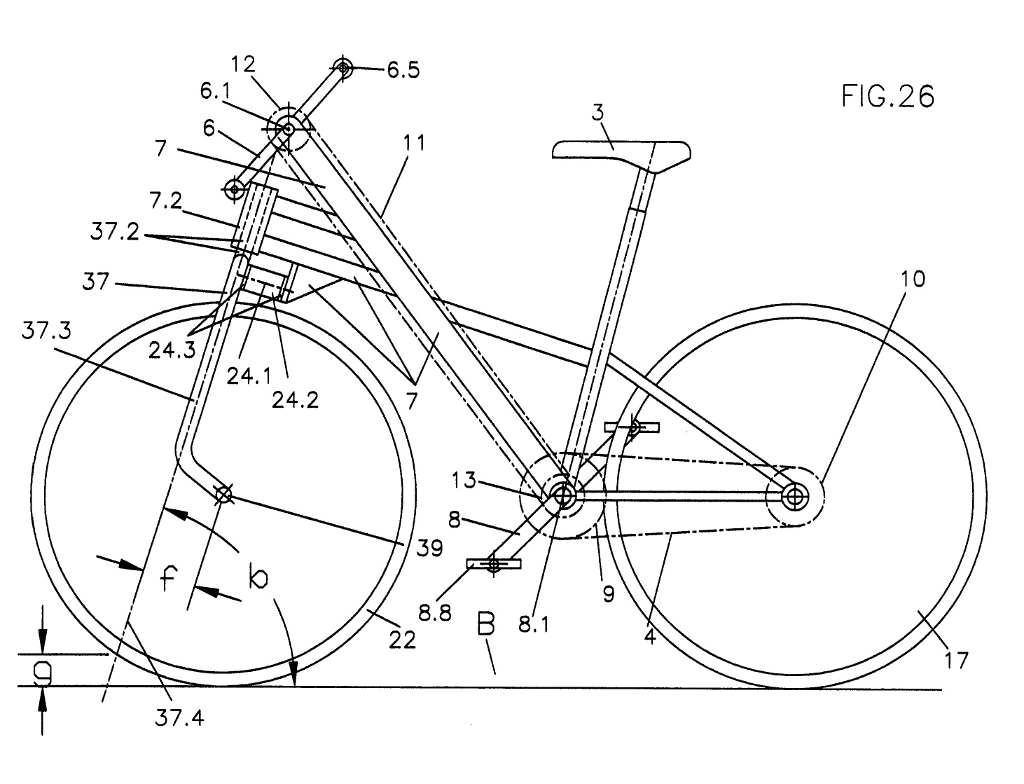

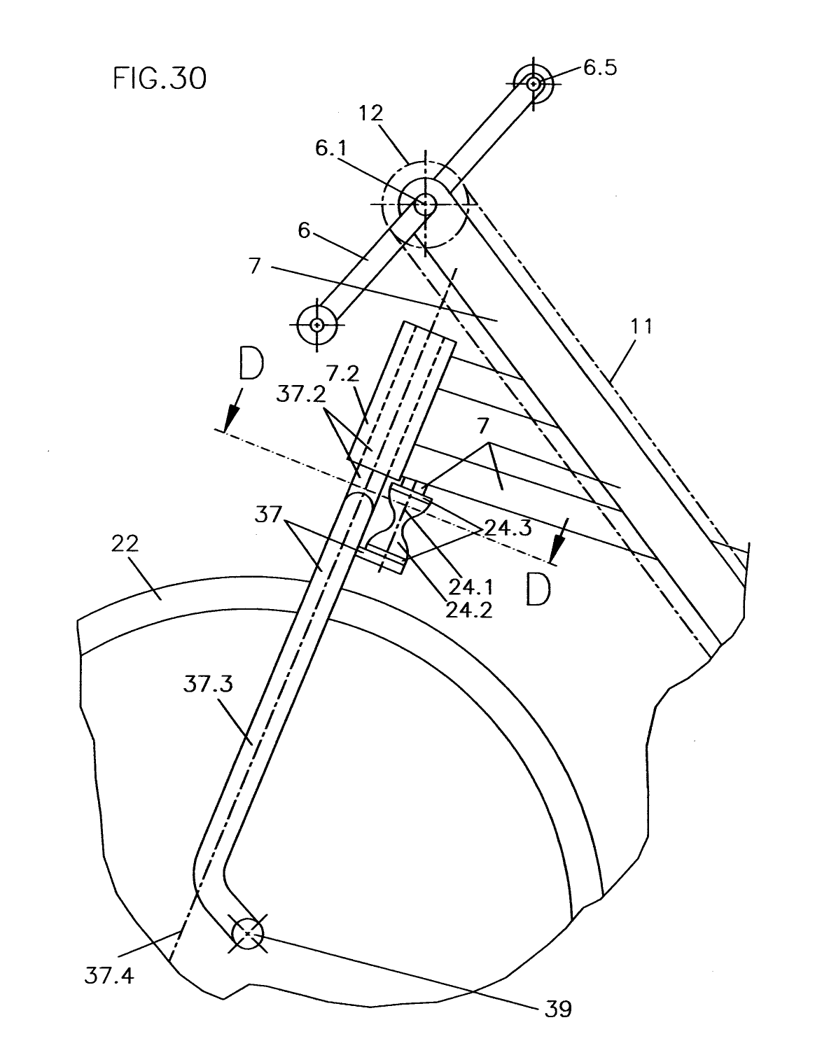

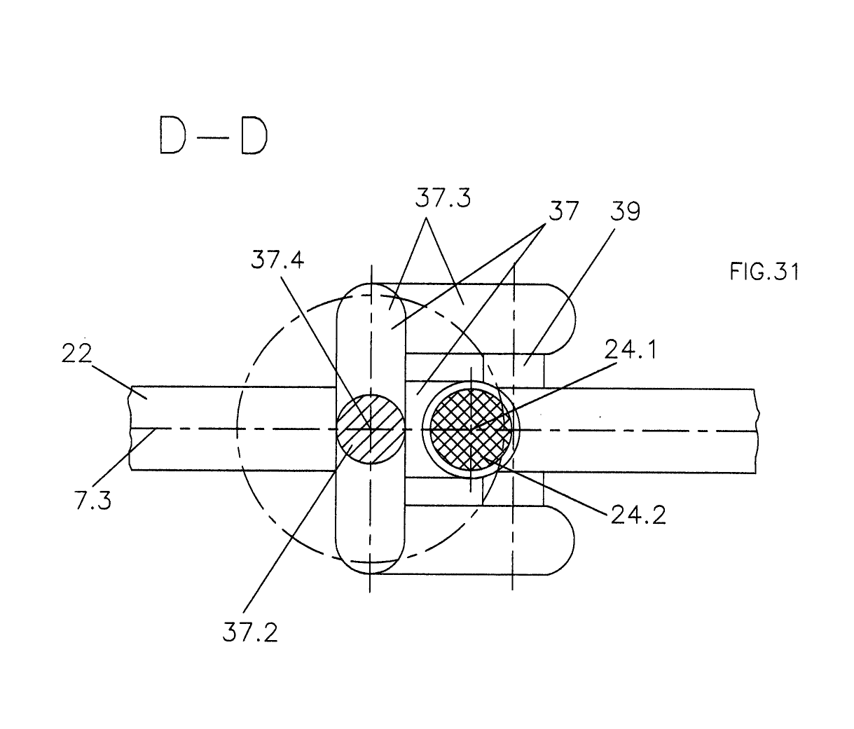

The variant D4 to which the invention relates corresponds to variant D to which the invention relates. In the variant D4 to which the invention relates the reset element is a spring which is mounted between the cycle frame 7 and the stub axle 37. In the event of a steering movement, the longitudinal axle 24.1 of the spring 24 is bent, causing the spring 24 to exert a reset force on the stub axle 37. The spring 24 is a so-called rubber-metal mounting. This rubber-metal mounting is a rubber element 24.2 which is permanently connected to a steel flank 24.3 on each of its opposite ends (FIGS. 19, 30, 31). FIGS. 26, 27, 39, 40, 41, 43, 44 show side views of the variant to which the invention relates. FIGS. 19, 30 each show a part of the side view of a cycle to which the invention relates. FIG. 31 shows section D-D of FIG. 30. The two steel flanks 24.3 serve to bolt on the rubber element. One steel flank 24.3 is permanently bolted to the stub axle 37 and the other steel flank 24.3 is permanently bolted to the cycle frame 7.

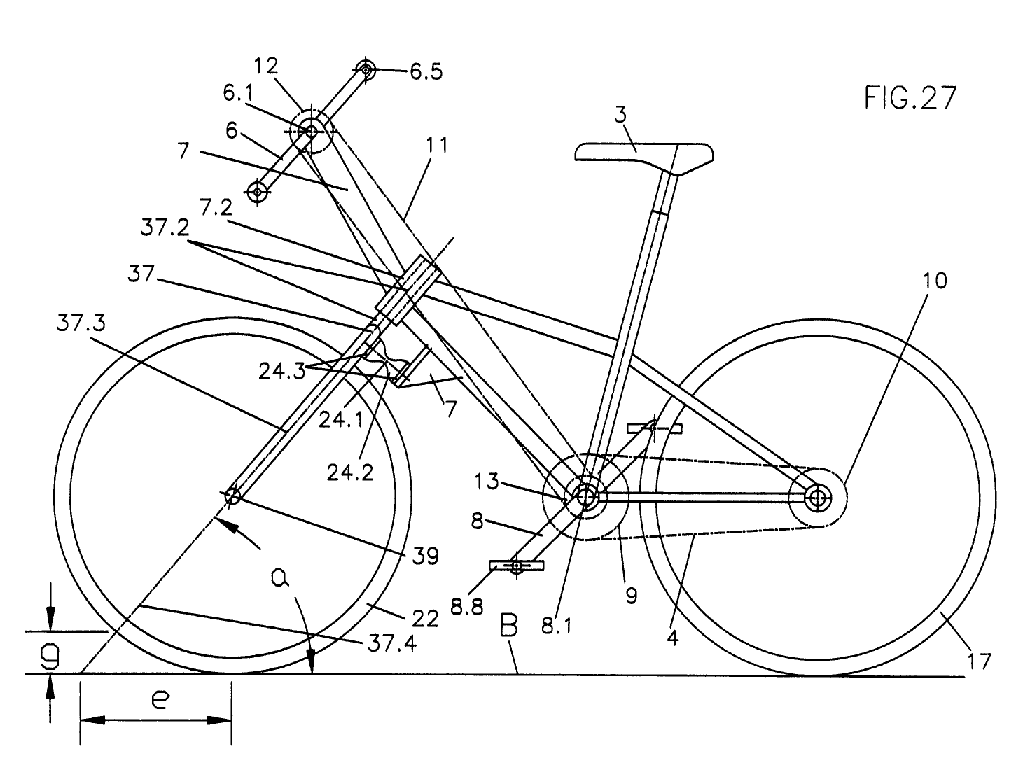

The rubber element 24.2 is cylindrical, rectangular or has the shape of a diabolo. In FIGS. 19, 26, 41, 43, 44 the rubber element is cylindrical and in FIGS. 27, 30, 31 it has the form of a diabolo.

Alternatively to the rubber element, the reset element is a coil spring, which is also mounted between the cycle frame 7 and the stub axle 37.

Alternatively, only one end of the reset element is permanently mounted on the stub axle 37 or on the cycle frame 7. The other end is rotatably mounted on the stub axle 37 or on the cycle frame 7 (not illustrated).

As the steering movement increases, the reset element of the variant D4 to which the invention relates exerts an increasing reset force on the stub axle 37.

The variant D5 to which the invention relates corresponds to the variant D to which the invention relates. In the variant D5 to which the invention relates the reset element has a connecting link. The axle 37.2 of the stub axle 37 is rotatable around its longitudinal axis and is axially displaceably mounted along its longitudinal axis in the headset bearing tube 7.2. This bearing is preferably a sliding bearing, or an axially sliding roller bearing.

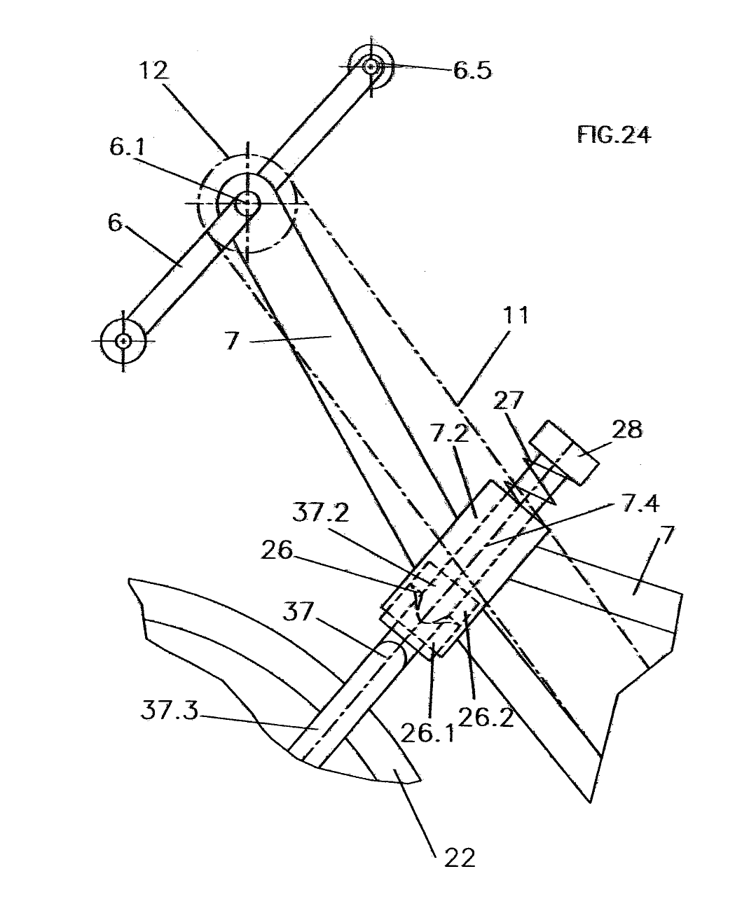

On the axle 37.2 of the stub axle 37 there is a connecting link 26 (FIG. 24) between the stub axle 37 and the headset bearing tube 7.2 of the cycle frame 7. FIG. 24 shows a part of the side view of a cycle to which the invention relates. The connecting link 26 consists of two link-shaped rings. One ring 26.1 is permanently connected to the stub axle 37 and one ring 26.2 is permanently connected to the headset bearing tube 7.2. To pretension the connecting link 26 there is a leg spring 27 on the axle 37.2, between an adjusting screw 28 and the headset bearing tube 7.2. The adjusting screw 28 is screwed onto the upper end of the axle 37.2. This can be used to adjust the pretension of the coil spring 27. With each steering movement of the stub axle 37 the two rings 26.1, 26.2 of the connecting link 26 are turned in opposite directions to each other. This reduces the spring travel of the coil spring 27 and tensions this spring further. The spring force and the force of gravity of the cycle and of the cyclist lead to a reset force of the stub axle 37 in straight-ahead position.

The connecting link brings about a certain reset force, depending on the steering angle. This depends on the pitch of the connecting link.

The advantage of the connecting link is that the pitch of the connecting link can be selected in such a way that it brings about the optimum reset force for one steering angle. For certain cycle geometries this can be such that the reset force to a straight-ahead position is greatest when the steering movements are small and diminishes as the steering movement increases.

In the illustrated connecting link 26 the two rings 26.1, 26.2 slide towards each other when they turn in relation to each other.

Alternatively, between the two rings 26.1, 26.2 there are balls between the connecting links of the rings 26.1, 26.2 (not illustrated). These reduce the friction between the two rings 26.1, 26.2. The connecting links preferably have grooves, similar to those in deep-groove ball bearings, which serve as races for the balls. The grooves reduce the Hertzian pressure between balls and their races.

As an alternative to balls, between the two rings 26.1, 26.2 there are rollers between the connecting links of the rings 26.1, 26.2 (not illustrated). These also reduce the friction between the two rings 26.1, 26.2. Alternatively, these rollers are mounted on the ring 26.2 in their longitudinal axis and can roll off the second ring 26.1 (not illustrated).

The variant D6 to which the invention relates corresponds to the variant D to which the invention relates. In the variant D6 at least one reset element is arranged in such a way that as the steering movement increases, the reset force on the stub axle through the reset element not only increases proportionally, that is, in a linear manner, but disproportionately, that is, progressively. This corresponds to a disproportionate increase in the reset force through this reset element on the stub axle 37 as the steering movement increases.

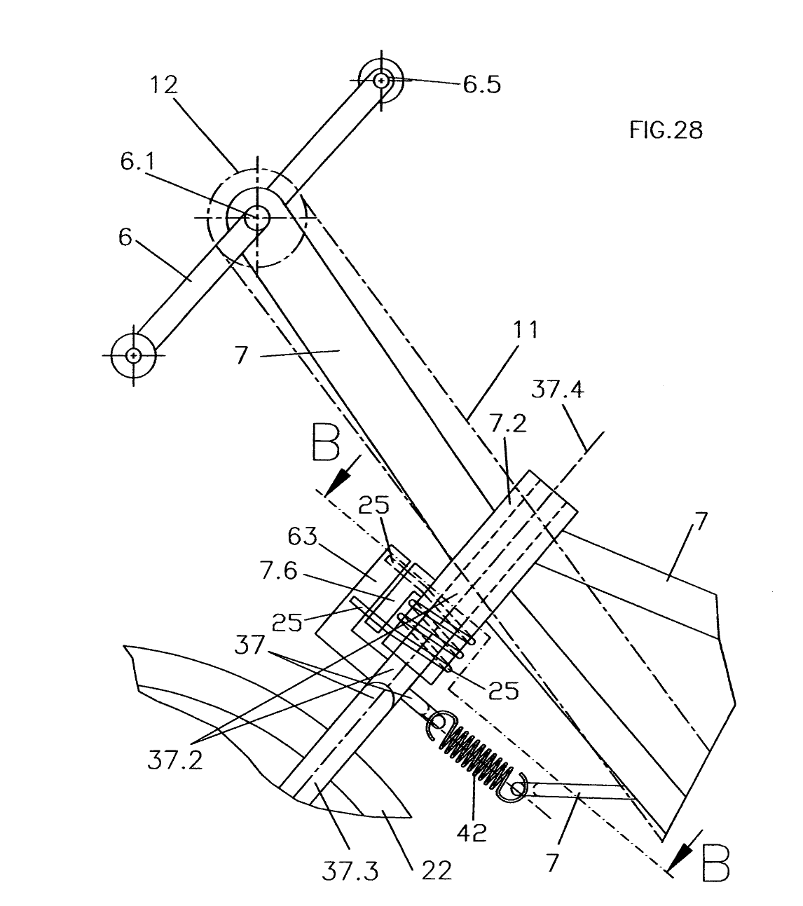

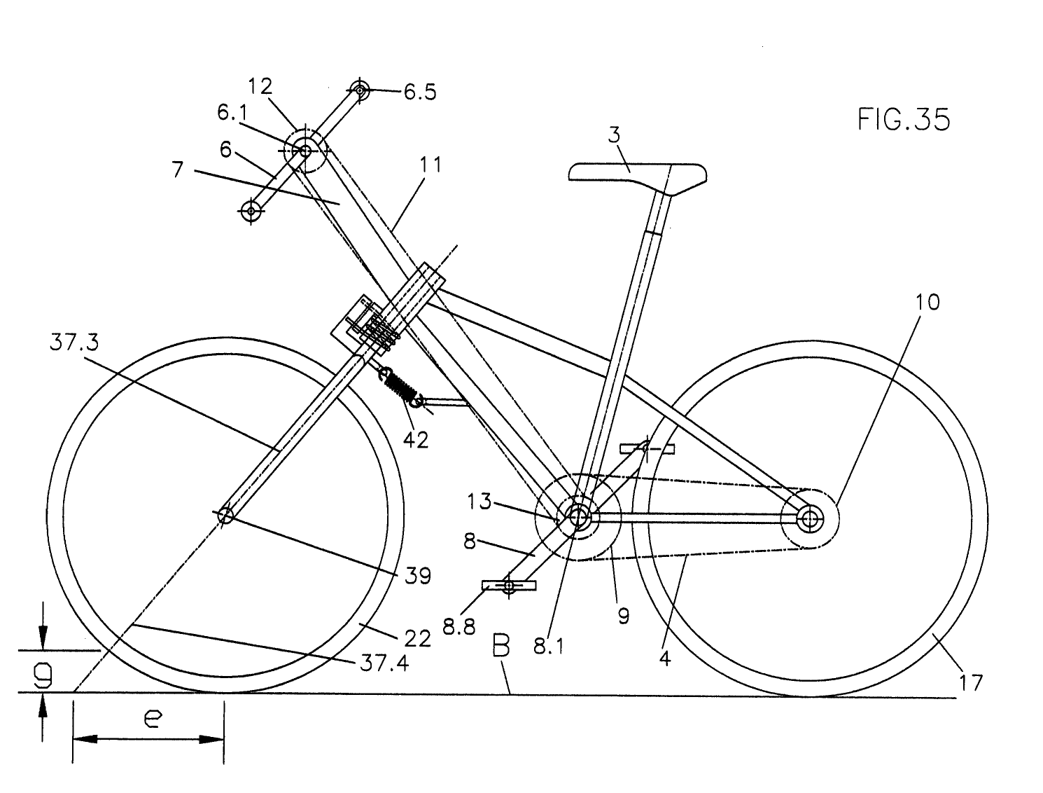

FIG. 35 shows the side view of an embodiment of the variant D6 to which the invention relates, in which such a reset element is a screw tension spring 42. FIG. 28 shows a section of FIG. 35. FIG. 29 shows section B-B of FIG. 28. The screw tension spring 42 is connected at one end to the cycle frame 7 and at its other end to the stub axle 37. In the event of a steering movement, the end of the screw tension spring 42 connected to the stub axle 37 makes a swinging movement around the steering axis 37.4, approximately along the circle 42.1. Through this swinging movement in relation to the other end of the screw tension spring 42, the reset force of the screw tension spring 42 increases disproportionately in the event of a steering movement. The embodiment also has a reset element as embodied in the variant of FIGS. 20, 21, 22, 23 to which the invention relates.

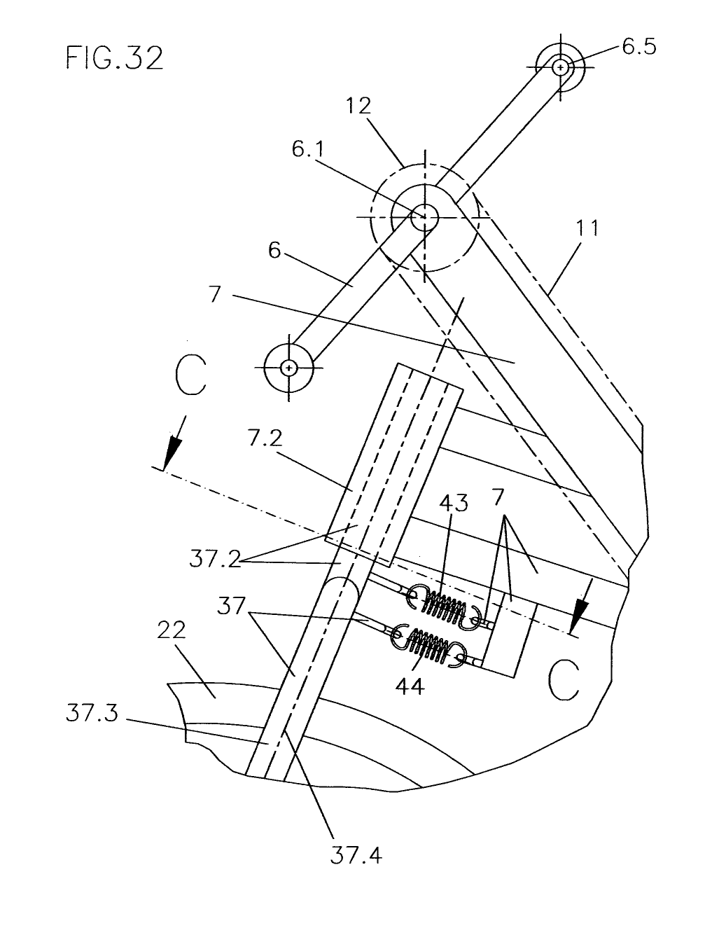

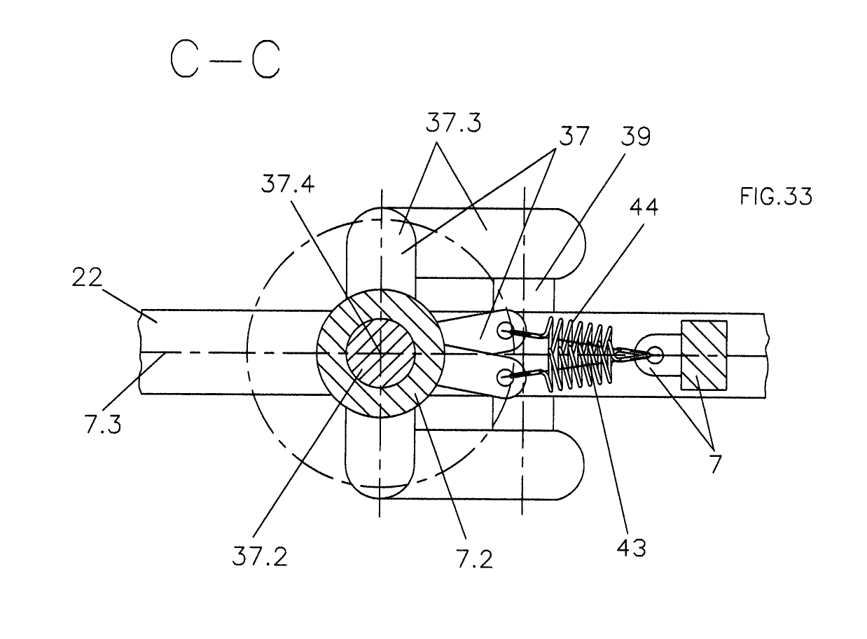

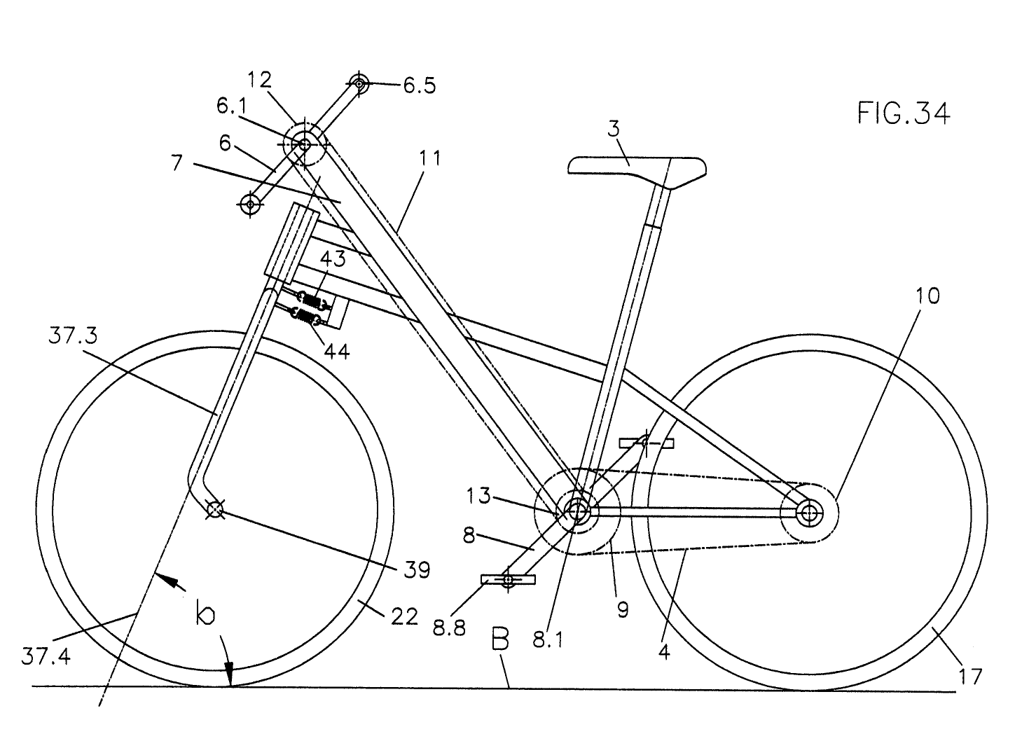

As an alternative to a screw tension spring 42 and a leg spring 25, the reset element in another embodiment of variant D to which the invention relates has two screw tension springs 43, 44 and no leg spring 25. FIG. 34 shows the side view of the embodiment. FIG. 32 shows a section of FIG. 34. FIG. 33 shows section C-C of FIG. 32. In that the screw tension springs 43, 44 are not positioned parallel to the center axis of the cycle 7.3 (FIG. 33), in the event of small steering movements of the stub axle 37 they bring about a greater reset force than the screw tension spring 42 in the embodiment in FIGS. 28, 29, 35.

The springs of the reset elements of variant D to which the invention relates have a degressive, linear or progressive spring curve of the power-distance behavior. Springs with a degressive curve are advantageous when, on account of the cycle geometry (trail, angle of the steering axis in relation to the contact surface etc.) the reset force of the cycle steering, without the reset force of the reset element, increases as the steering movement increases on account of a lifting of the cycle. In this case the additional reset force of the recoil spring is especially required when the steering movement is small.

Springs with a progressive curve are advantageous when, on account of the cycle geometry (trail, angle of the steering axis in relation to the contact surface etc.) the reset force of the cycle steering, without the reset force of the reset element, is on the one hand negative and becomes increasingly negative as the steering movement increases. Here, a reset element with a progressive curve can ensure that the entire reset force, that is, the sum of the negative reset force of the cycle steering and the reset force of the reset element, becomes positive over the entire steering angle range.

The variant E to which the invention relates corresponds to the variant B1 to which the invention relates.

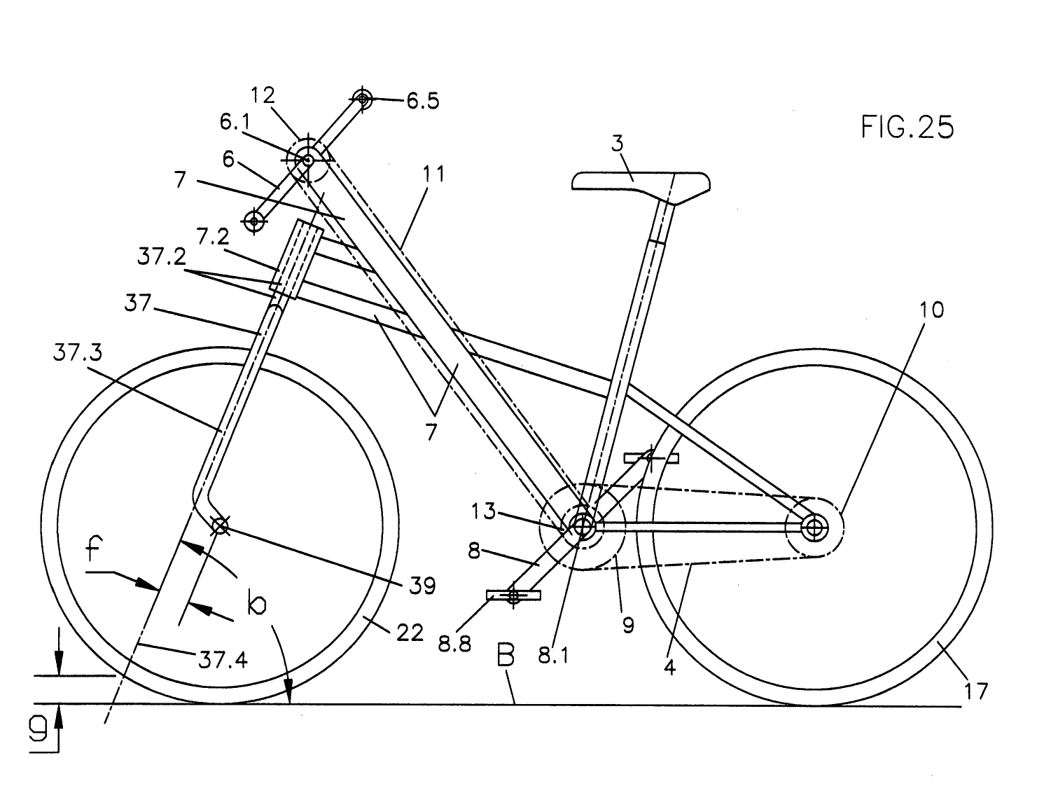

Unlike the variant B1 to which the invention relates, however, the steering axis 37.4 in the variant E to which the invention relates is located in front of the axle 39 of the front wheel 22, seen in the direction of travel (FIGS. 25, 26).

Moreover, in the variant E to which the invention relates, seen in the direction of travel, the fork bend, the so-called rake f, points rearwards instead of forwards as in conventional cycles. The rake f is the distance from the axle 39 of the front wheel 22 to the steering axis 37.4. In the variant E to which the invention relates, the rake f is 0 mm to 200 mm, preferably 50 mm to 150 mm, in particular 70 mm to 130 mm. The advantage of the rake f pointing rearwards is that the distance g is greater than with a cycle with the same angle b but with the rake pointing forwards. The distance g is the distance from the contact surface B to the point of intersection of the steering axis 37.4 and the outer diameter of the front wheel. A large distance g makes it possible to drive through relatively deep potholes without an extreme lateral movement of the front wheel 22.

Moreover, the angle range of the steering axis 37.4 in relation to the contact surface B of the cycle is different from that of the variant B1 to which the invention relates. The steering axis 37.4 of variant E to which the invention relates is at an angle b of 30° to 95°, preferably 55° to 80° in relation to the contact surface B of the cycle, proceeding from the contact surface B.

In the variant E to which the invention relates, angles b of less than 80° compared to angles b of more than 80° have the advantage that the cycle can be built to be more compact and lighter, since the cycle frame 7 is shorter as the headset bearing tube 7.2 is located in a position closer to the saddle 3.

Moreover, when angle b is less than 80°, conventional suspension forks with telescopic tubes are suitable as a stub axle 37, whereby, however, the fork bend, that is, the rake f, points backwards in the variant E to which the invention relates, instead of pointing in the direction of travel as in conventional cycles.

The variant E1 to which the invention relates is an embodiment to which the invention relates of variant E to which the invention relates. Here, the variant E1 to which the invention relates has at least one reset element of the variants D to which the invention relates.

The variant E1 to which the invention relates has an angle b of 90 to 55°, preferably of 82° to 60°, in particular of 75° to 68°, in conjunction with a rake f of 30 mm to 170 mm, preferably of 50 mm to 150 mm, in particular of 70 mm to 130 mm.

The reset element is of advantage at angles b of less than 90°. FIG. 26 shows the side view of an embodiment of the variant E1 to which the invention relates with a reset element of the variant D4 to which the invention relates.

At angles b of less than 90°, in conjunction with a steering axis 37.4 in front of the axle 39 of the front wheel 22, the cycle is lowered in the event of a steering movement and thus loses potential energy. Through this property, the variant E to which the invention relates, at angles b of less than 90°, has no reset force of the front wheel 22 to a straight-ahead position when the cycle is standing vertically on the contact surface B. In the variant E1 to which the invention relates, a reset element of the variant D to which the invention relates takes over this reset force.

In the variant E1 to which the invention relates, angles b of more than 55° have the advantage that the reset force to be exerted in straight-ahead position is lower than with smaller angles b.

An angle b range from 80° to 55° is therefore advantageous. An angle b range of 75° to 68° is especially advantageous, for with an angle b of less than 75°, the cycle frame 7 can be even more compact than with an angle b of less than 80° and with an angle b of more than 68° the reset force to be exerted in straight-ahead position is even less than with an angle b of more than 55°.

The variant E1 to which the invention relates with an angle b of 75° to 68° in conjunction with a rake f of 70 mm to 130 mm is especially advantageous for the following reasons.

With this geometrical combination of angle b and rake f, the loss of potential energy in the event of a steering movement is relatively small (compared with other combinations of angle b and rake f), with simultaneously large distance g.

A reset element with relatively low reset force is thus sufficient. At the same time the large distance g makes it possible to drive through relatively deep potholes without an extreme lateral movement of the front wheel 22, and at the same time the cycle frame can be relatively compact thanks to the not very large angle b.

FIG. 26 shows an embodiment of the variant E1 to which the invention relates with a reset element of the variant D4 to which the invention relates in the form of a rubber element 24.2 with two steel flanks 24.3.

The variant F to which the invention relates corresponds to the variant B1 to which the invention relates. Unlike the variant B1 to which the invention relates, the angle a of variant F to which the invention relates is from 30° to 70°, preferably from 40° to 60°, in particular from 45° to 55°. Here the angle a is the angle of the steering axis 37.4 in relation to the contact surface B of the cycle, proceeding from the contact surface B.

Unlike the variant B1 to which the invention relates, in the variant F to which the invention relates the steering axis 37.4 runs approximately through the axle 39 of the front wheel 22 (FIG. 27). The stub axle 37 thus has no rake.

The advantage compared to the variant B1 is that the distance g is greater. A large distance g makes it possible to drive through relatively deep potholes without an extreme lateral movement of the front wheel 22. Moreover, the stub axle tubes 37.3 can be manufactured straight, that is, without a bend for the rake f, which saves manufacturing costs and weight.

The variant to which the invention relates is especially advantageous when it is equipped with the reset element to which the invention relates of the variant D to which the invention relates, since on account of the angle a and on account of the absence of rake f of the stub axle 37, this variant has no reset force in straight-ahead position, but the front wheel 22 tends to tilt laterally when driving slowly straight ahead. The reset element makes the cycle more directionally stable by ensuring the necessary reset force in straight-ahead position.

For all variants to which the invention relates, a front wheel 22 which has a diameter of more than 600 mm is generally particularly advantageous. Embodiments with front wheel diameters of more than 700 mm run even more smoothly.

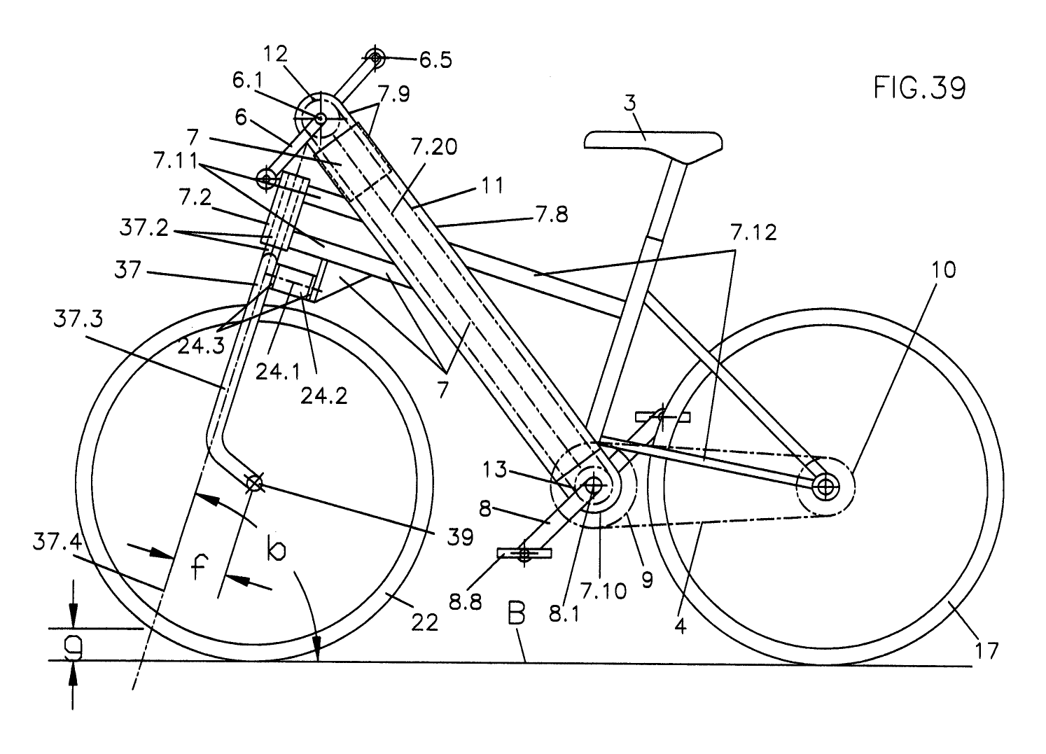

The variant G to which the invention relates corresponds to at least one of the other variants to which the invention relates or one of the variants A4, A5, A6, A8 of the European patent application EP 1 982 908 A1. In the variant G to which the invention relates, however, the synchronizing chain 11 runs in the center axis of the cycle. The synchronizing chain chainwheel 12 of the hand crank 6 is permanently connected to the axle 6.1 of the hand crank 6 and is located between the bearings of the axle 6.1 (FIG. 39). The lower synchronizing chain chainwheel 13 is permanently connected to the axle 8.1 of the leg crank 8 and is located between the bearings of the axle 8.1. The two synchronizing chain chainwheels 12, 13 and the synchronizing chain 11 are protected from dirt in the inner compartment that is formed by the cycle frame tube 7.8 and the housings 7.9, 7.10. In the housings 7.9, 7.10 the axle 6.1 and the axle 8.1 respectively are rotatably mounted by means of the bearings of the axles 6.1, 8.1. The housing 7.10 is bolted to the cycle frame tube 7.8. The design principle of the unit of the housing 7.9 and of the cycle frame tube 7.8 corresponds approximately to the frame tube/housing unit of the GreenMachine recumbent cycle by the company Flevobike in Dronten, Netherlands, in particular the upper frame tube/housing unit of the GreenMachine, in which the leg crank is mounted and in which the chain runs approximately in the center of the cycle. In the variant G to which the invention relates the synchronizing chain 11 is tensioned in that the upper housing 7.9 is slidably mounted in the cycle frame tube 7.8, so that it can slide along the longitudinal axis of the cycle frame tube 7.20. Here the housing 7.9 is connected to the cycle frame tube 7.8 by screws in slots that run parallel with the longitudinal axis of the cycle frame tube 7.20 (not illustrated). To slide the housing 7.9 the screws in the slots are loosened and are tightened again after the housing has been moved in order to connect the housing 7.9 firmly with the frame tube 7.8. As an alternative to screws in slots, the housing 7.9 is clamped in the frame tube 7.8. Here the frame tube 7.8 is slotted at the clamping point and has at least one clamping screw (not illustrated). Clamping functions according to the same principle as the standard clamping of a seatpost in the seat tube of a conventional cycle.

As an alternative to a sliding housing 7.9, housing 7.9 of the variant to which the invention relates is firmly bolted to the cycle frame tube 7.8 and the synchronizing chain 11 is tensioned by means of an eccentric bearing holder of one of the axles 6.1, 8.1 or by means of a chain tensioner in the inside of the cycle frame tube 7.8 (not illustrated).

The cycle frame tube 7.8 to which the invention relates is permanently connected to the headset bearing tube by means of at least one cycle frame tube 7.11 and to the rear wheel mount by means of at least one cycle frame tube 7.12. These thus form the cycle frame 7.

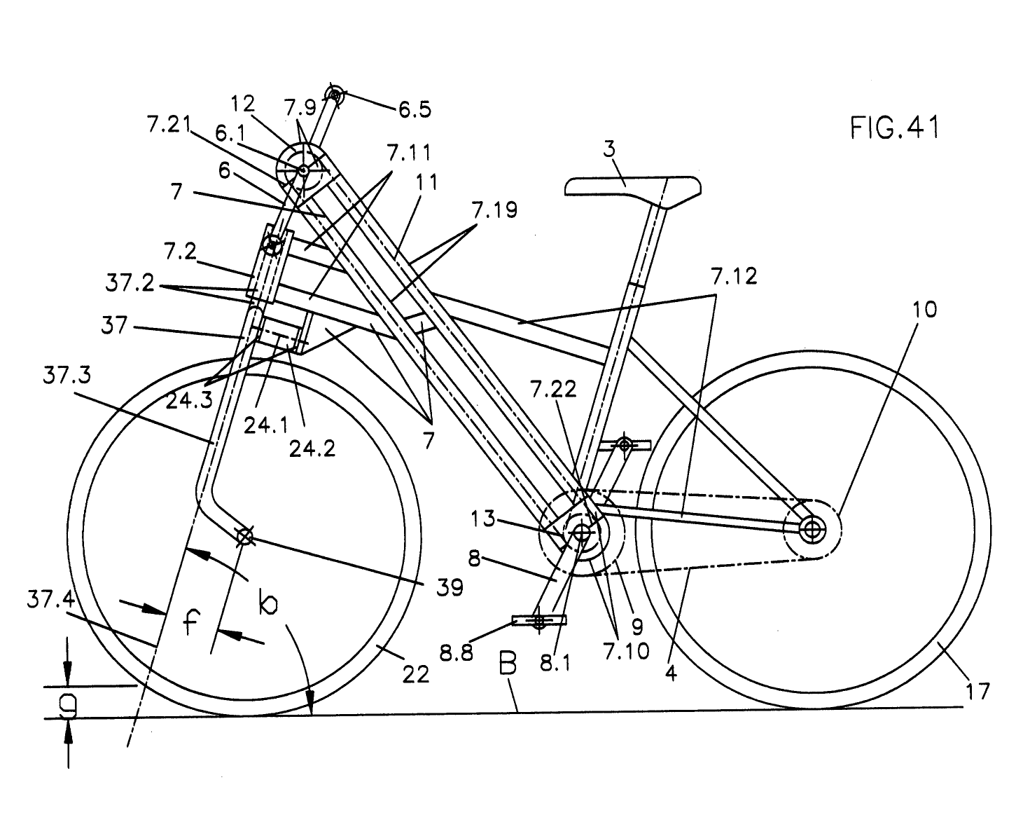

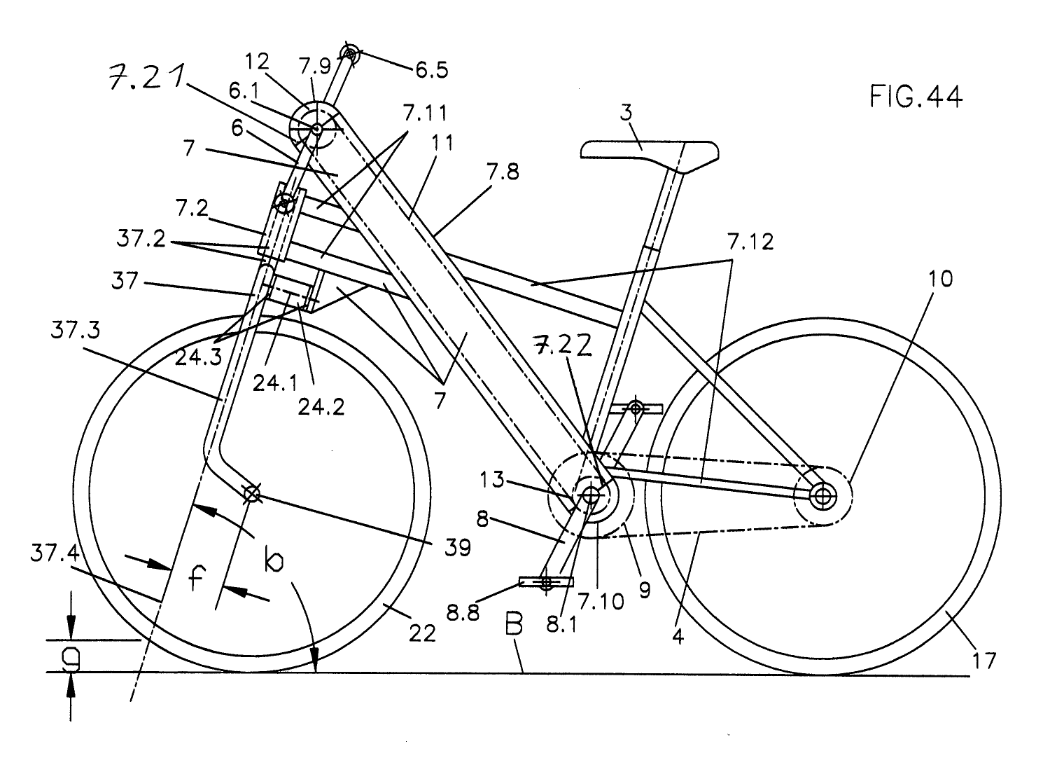

Alternatively the connecting surfaces, the so-called dividers 7.21, 7.22, run between the cycle frame tube 7.8 and the housings 7.9, 7.10 through the bearing seats of the bearings of the axles 6.1, 8.1 (FIG. 44). The function of the dividers is described in more detail in the description of the embodiment of FIG. 41.

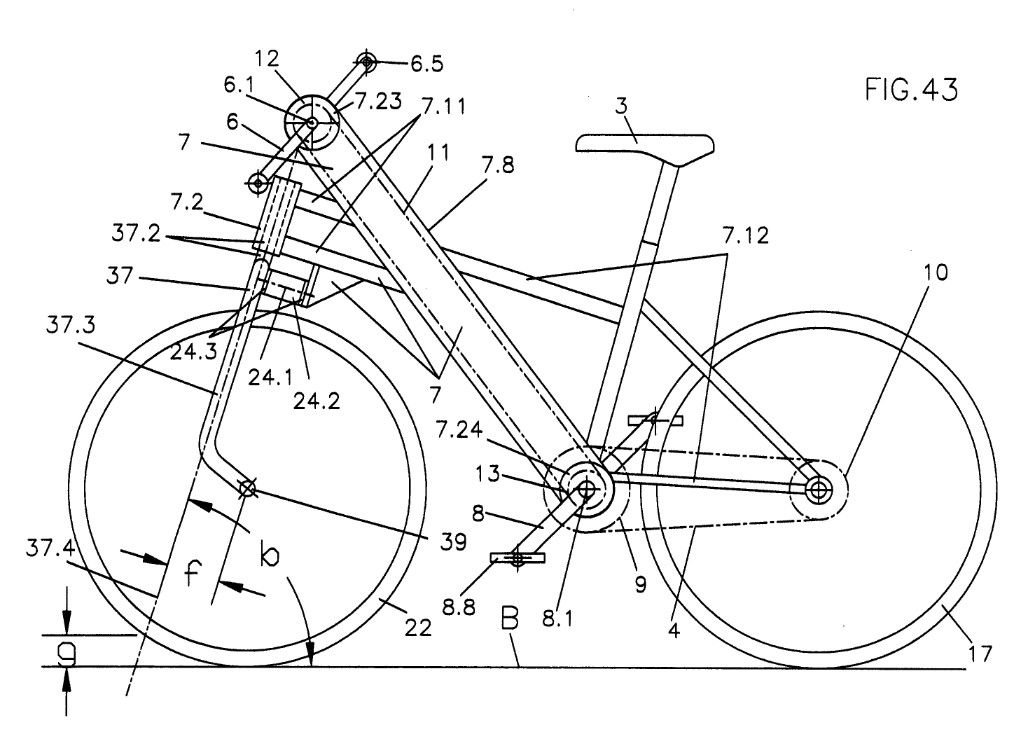

Alternatively to the housings 7.9, 7.10, the cycle frame tube 7.8 also encompasses the synchronizing chainwheels 12, 13 (FIG. 43). In this embodiment, the cycle frame tube 7.8 has an opening for each synchronizing chainwheel 12, 13 on the left-hand side for inserting and mounting the respective synchronizing chainwheels 12, 13 of the axles 6.1, 8.1 and of the synchronizing chain 11. Each of these openings is closed after assembly with one housing cover 7.23, 7.24. To do this, the housing covers 7.23, 7.24 are bolted to the cycle frame tube 7.8. In this alternative embodiment of variant G to which the invention relates the axles 6.1, 8.1 are each rotatably mounted to the right of the respective synchronizing chainwheel 12, 13 in cycle frame tube 7.8 and to the left of the respective synchronizing chainwheel 12, 13 in the housing cover 7.23, 7.24.

Alternatively, the cycle frame tube is connected to the rear wheel mount by means of at least one rear wheel suspension unit (not illustrated). As an alternative to the cycle frame tube 7.8 with its large cross-section, the synchronizing chain 11 runs in two cycle frame tubes 7.19 with smaller cross-sections (FIG. 41). The ends of each of these cycle frame tubes 7.19 are permanently connected to divisible housings 7.9, 7.10. In these divisible housings 7.9, 7.10 are the respective synchronizing chainwheels 12, 13 and in these the respective axles 6.1, 8.1 are rotatably mounted, whereby the dividers 7.21, 7.22 of the divisible housings 7.9, 7.10 each run through the bearing seats of the bearings of axles 6.1, 8.1, so that the synchronizing chainwheels 12, 13, the axles 6.1, 8.1 and the synchronizing chain 11 can be mounted.

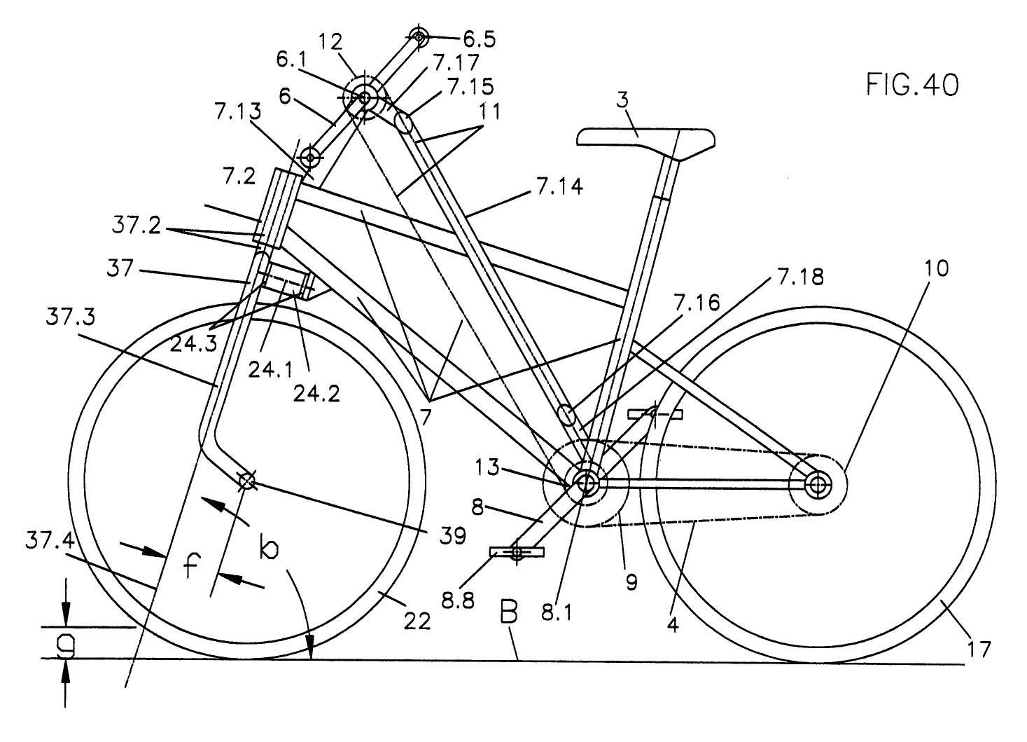

The variant H to which the invention relates corresponds to at least one of the other variants to which the invention relates or one of the variants A4, A5, A6, A8 of the European patent application EP 1 982 908 A1. However, to support the hand crank bearing on the cycle frame 7, a cycle frame tube 7.13 runs in the center axis of the cycle in the direction of the front part of the cycle frame and connects the cycle frame 7 with the hand crank bearing (FIG. 40). Furthermore, the tubes 7.17, 7.14, 7.18 connect the hand crank bearing with the cycle frame. A cycle frame tube 7.17 runs from the hand crank bearing in the center axis of the cycle to beside the center axis of the cycle. This cycle frame tube 7.17 is permanently connected to a cycle frame tube part 7.14. A cycle frame tube 7.18 is permanently connected to a cycle frame tube part 7.14 and runs to the center axis of the cycle, where it is permanently connected to the cycle frame 7.

This cycle frame tube part 7.14 runs along the longitudinal axis of the synchronizing chain 11 and encompasses the latter on this cycle frame tube part 7.14. The synchronizing chain 11 enters the cycle frame tube part 7.14 through the opening 7.16 and leaves the cycle frame tube part 7.14 through the opening 7.15. The advantage of this arrangement of the cycle frame tube is that the cycle frame tube part 7.14 serves to support the hand crank bearing and at the same time to protect the synchronizing chain.

Alternatively, instead of a synchronizing chain 11 and the synchronizing chainwheels 12, 13, a cardan shaft drive is used in the variants to which the invention relates.

The patent claims mark the scope of protection. The descriptions are embodiments of the inventive ideas.

### NUMBERING IN ACCORDANCE WITH THE DRAWINGS

3 Saddle
4 Drive chain
6 Hand crank
6.1 Axle
6.5 Hand crank handle
7 Cycle frame
7.1 Frame piece
7.2 Headset bearing tube
7.3 Cycle center axis
7.5 Limit stop
7.6 Limit stop
7.7 Limit stop
7.8 Cycle frame tube
7.9 Housing
7.10 Housing
7.11 Cycle frame tube
7.12 Cycle frame tube
7.13 Cage
7.14 Cycle frame tube part
7.15 Opening
7.16 Opening
7.17 Cycle frame tube
7.18 Cycle frame tube
7.19 Cycle frame tube
7.20 Longitudinal axis of cycle frame tube
7.21 Divider
7.22 Divider
7.23 Housing cover
7.24 Housing cover
8 Leg crank
8.1 Axle
8.8 Pedal
9 Drive chainwheel
10 Drive cog
11 Synchronizing belt or synchronizing chain
12 Synchronizing pulley or synchronizing chainwheel
13 Synchronizing pulley or synchronizing chainwheel
17 Rear wheel
22 Front wheel
23.1 Coil spring
23.2 Coil spring
24.1 Longitudinal axis
24.2 Rubber element
24.3 Steel flank
25 Leg spring
26 Connecting link
27 Coil spring
28 Adjusting screw
30 Shaft
31 Limit stop
32 Bowden cable
33 Spring
34 Linear bearing
35 Friction surface
36 Brake
37 Stub axle
37.2 Axle
37.3 Stub axle tube
37.4 Steering axis
39 Axle
40 Axle
41 Limit stop
42 Screw tension spring
43 Screw tension spring
44 Screw tension spring
62 Rod
63 Carrier
64.1 Rubber buffer
64.2 Rubber buffer
65 Star gear

1-13. (canceled)

14. A cycle with two wheels comprising:
at least one hand crank; and
at least one leg crank; and
steering that includes at least one stub axle and at least one steering support element.

15. The cycle in accordance with claim 14, wherein the at least one stub axle is movably mounted in relation to the cycle frame.

16. The cycle in accordance with claim 14, wherein a minimum of one steering axis is located behind an axle of the front wheel and has a rake f of 0 mm to 400 mm, preferably of 40 mm to 250 mm, in particular of 70 mm to 150 mm.

17. The cycle in accordance with claim 14, wherein at least one steering support element is a steering angle limiter and/or a steering damper and/or a steering fixing device and/or a reset element.

18. The cycle in accordance with claim 14, wherein the at least one steering axis is located in front of an axle of the front wheel.

19. The cycle in accordance with claim 14, wherein the at least one steering axis is located approximately on or behind an axle of the front wheel.

20. The cycle in accordance with claim 14, wherein, proceeding from a contact surface B of the cycle, a minimum of one steering axis is inclined at an angle b of 30° to 95°, preferably of 55° to 80°, in particular of 68° to 75° in relation to the contact surface B of the cycle.

21. The cycle in accordance with claim 14, wherein a minimum of one steering axis is located in front of an axle of the front wheel and that the cycle has a rake f of 0 mm to 200 mm, preferably of 50 mm to 150 mm, in particular of 70 mm to 130 mm.

22. The cycle in accordance with claim 14, wherein the at least one stub axle is rotatably mounted on at least one steering axis in relation to the cycle frame.

23. The cycle in accordance with claim 14, wherein the at least one stub axle is swivel-mounted around at least one steering axis.

24. A method of driving a cycle with two wheels, with at least one arm drive and at least one leg drive, the method comprising:
driving the cycle with arm crank movements and/or leg crank movements;
steering the cycle by inclining the cycle frame against the contact surface B wherein at least one steering support element damps and/or fixes and/or limits the steering movement and/or exerts a reset force on the steering movement.

25. The method in accordance with claim 24, wherein when the steering movement takes place, at least one stub axle swivels around at least one steering axis.

26. A cycle with two wheels comprising:
at least one hand crank; and
at least one leg crank; and
steering that includes at least one stub axle wherein the stub axle is moveably mounted around at least one steering axis; and
at least one steering support element which includes a steering angle limiter and/or a steering damper and/or a steering fixing device and/or a reset element.

27. The cycle in accordance with claim 26, wherein, proceeding from a contact surface B of the cycle, the minimum of one steering axis is inclined at an angle b of 30° to 95°, preferably of 55° to 80°, in particular of 68° to 75° in relation to a contact surface B of the cycle.

28. The cycle in accordance with claim 26, wherein the minimum of one steering axis is located in front of an axle of the front wheel and that the cycle has a rake f of 0 mm to 200 mm, preferably of 50 mm to 150 mm, in particular of 70 mm to 130 mm.

29. The cycle in accordance with claim 27, wherein the minimum of one steering axis is located in front of an axle of the front wheel and that the cycle has a rake f of 0 mm to 200 mm, preferably of 50 mm to 150 mm, in particular of 70 mm to 130 mm.

30. The cycle in accordance with claim 26, wherein the at least one steering axis is located approximately on or behind an axle of the front wheel.

31. The cycle in accordance with claim 26, wherein a minimum of one steering axis is located behind an axle of the front wheel and has a rake f of 0 mm to 400 mm, preferably of 40 mm to 250 mm, in particular of 70 mm to 150 mm.
